(19) United States
(12) Patent Application Publication
(10) Pub. No.: US 2026/0200396 A1
(43) Pub. Date: Jul. 16, 2026

(54) CONTROL DEVICE, CONTROL METHOD, AND CONTROL PROGRAM

(71) Applicant: HONDA MOTOR CO., LTD., Tokyo (JP)

(72) Inventors: Ayumu MITOMO, Tokyo (JP); Gaku SHIMAMOTO, Tokyo (JP); Junpei NOGUCHI, Tokyo (JP); Tomonori WATANABE, Tokyo (JP); Tomoya OKUDA, Tokyo (JP); Yusuke URANO, Tokyo (JP)

(73) Assignee: HONDA MOTOR CO., LTD., Tokyo (JP)

(21) Appl. No.: 19/138,103

(22) PCT Filed: Dec. 14, 2022
(86) PCT No.: PCT/JP2022/046071

§ 371 Date: Jun. 12, 2025

(51) Int. Cl. B60Q 1/50; B60Q 1/04; B60W 30/18

(52) U.S. Cl. CPC B60Q 1/543; B60Q 1/04; B60W 30/18009; B60Q 2300/314; B60W 2556/45; B60W 2720/10

(57) ABSTRACT

A control device for a moving object includes: a movement controller configured to execute movement control of the moving object; and a notification controller configured to provide a first notification from the moving object and a second notification from the moving object in a manner different from the first notification. The notification controller provides the first notification when an instruction for the movement control is received, and the notification controller provides the second notification after providing the first notification, and then executes the movement control.

### TECHNICAL FIELD

The present invention relates to a control device, a control method, and a control program.

### BACKGROUND ART

In recent years, active efforts have been made to provide access to a sustainable transportation system in consideration of vulnerable people among traffic participants. In order to implement the above, focus has been placed on research and development on further improving safety and convenience of traffic by research and development related to driving assistance techniques.

In the related art, there is known a remote parking system that remotely operates a vehicle to park the vehicle in a specified predetermined parking space or to cause the vehicle to exit from the parking space. Patent Literature 1 describes an in-vehicle notification device that, when a vehicle that receives an automated parking command signal from a remote control device is traveling unmanned, alerts people around the vehicle by turning on or blinking lights or outputting sound from a speaker at a timing when the vehicle starts from a stop state to an unmanned traveling state. Patent Literature 2 describes a parking assistance device that, when a parking assistance execution request is made, determines whether a vehicle is in a predetermined environment that is darker than a predetermined brightness level, and if it is determined that the vehicle is in the predetermined environment, turns on a lighting means without turning on a high beam. Patent Literature 3 describes a vehicle equipped with a driving assistance device in which, when a parking assistance start instruction means for instructing a start of operation of a parking assistance device is operated, a hazard lamp lighting means turns on a hazard lamp.

### CITATION LIST

Patent Literature 1: JO4754883B
Patent Literature 2: JP6773477B
Patent Literature 3: JP4114435B

### SUMMARY OF INVENTION

### Technical Problem

According to Patent Literatures 1 to 3, when a request for parking assistance is made for a moving object, a light is turned on at a predetermined timing, so that people around the moving object can recognize that the moving object is in a state at the predetermined timing. However, it is preferable for the people around the moving object to be able to more accurately recognize a moving state of the moving object during parking assistance, for example, to be able to recognize what stage of movement the moving object is in during parking movement. Therefore, there is room for improvement in a mode in which the moving state of the moving object is notified to those around.

An object of the present invention is to provide a control device, a control method, and a control program capable of accurately notifying people around a moving object of a moving state of the moving object. This contributes to development of a sustainable transportation system.

### Solution to Problem

The present disclosure is a control device for a moving object, the control device including:
a movement controller configured to execute movement control of the moving object; and
a notification controller configured to provide a first notification from the moving object and a second notification from the moving object in a manner different from the first notification, in which
the notification controller provides the first notification when an instruction for the movement control is received, and
the notification controller provides the second notification after providing the first notification, and then executes the movement control.

The present invention is a control method by a control device configured to perform movement control of a moving object and configured to provide a first notification from the moving object and a second notification from the moving object in a manner different from the first notification, the control method including:
providing, by a processor of the control device, the first notification when an instruction for the movement control is received; and
providing, by the processor, the second notification after providing the first notification, and then performs the movement control.

The present invention is a control program of a control device configured to perform movement control of a moving object and configured to provide a first notification from the moving object and a second notification from the moving object in a manner different from the first notification, the control program causing a processor of the control device to perform a process including:
providing the first notification when an instruction for the movement control is received; and
providing the second notification after providing the first notification, and then to perform the movement control.

### Advantageous Effects of Invention

The present invention can provide a control device, a control method, and a control program capable of accurately notifying people around a moving object of a moving state of the moving object.

### BRIEF DESCRIPTION OF DRAWINGS

FIG. 1 is a side view illustrating an example of a vehicle subjected to movement control by a control device according to the present embodiment.

FIG. 2 is a top view of the vehicle illustrated in FIG. 1.

FIG. 3 is a block diagram illustrating an internal configuration of the vehicle illustrated in FIG. 1.

FIG. 4 is a diagram illustrating an example of a hardware configuration of an information terminal.

FIG. 5 is a diagram illustrating an example of movement control of the vehicle from outside the vehicle using the information terminal.

FIG. 6 is a flowchart illustrating automated exiting control of the vehicle by a calculation unit.

FIG. 7 is a flowchart illustrating the automated exiting control following the processing of FIG. 6.

FIG. 8 is a sequence diagram illustrating a first operation example of a control system.

FIG. 9 is a sequence diagram illustrating a second operation example of the control system.

FIG. 10 is a sequence diagram illustrating a third operation example of the control system.

FIG. 11 is a sequence diagram illustrating a fourth operation example of the control system.

FIG. 12 is a disclaimer screen displayed on an information terminal that receives inquiry information regarding automated exiting.

FIG. 13 is a reception screen displayed on the information terminal when a communication connection process is being executed between the vehicle and the information terminal during automated exiting of the vehicle.

FIG. 14 is a reception screen displayed on the information terminal when the communication connection between the vehicle and the information terminal is completed.

FIG. 15 is a reception screen displayed on the information terminal during reception of an ignition ON instruction.

FIG. 16 is a reception screen displayed on the information terminal when an ignition ON button is pressed.

FIG. 17 is a reception screen displayed on the information terminal when an ignition ON button is pressed and ignition is started.

FIG. 18 is a reception screen displayed on the information terminal when an action plan for the vehicle starts to be received.

FIG. 19 is a reception screen displayed on the information terminal when the action plan for the vehicle is received.

FIG. 20 is a charge waiting screen displayed on the information terminal during charge waiting of a sub-power supply.

FIG. 21 is a reception screen displayed on the information terminal when a movement control execution instruction is received from a user.

### DESCRIPTION OF EMBODIMENTS

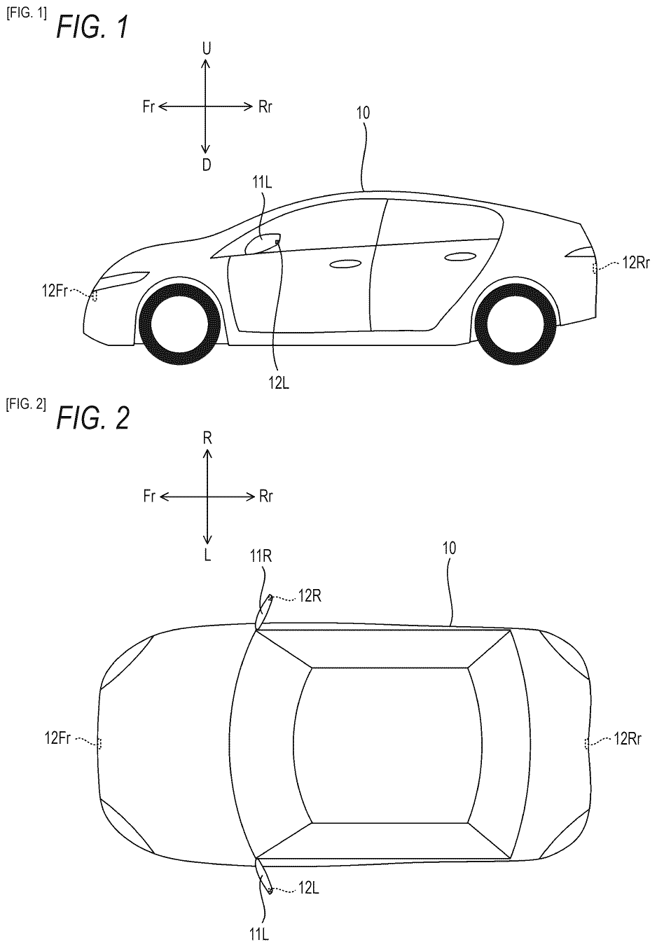

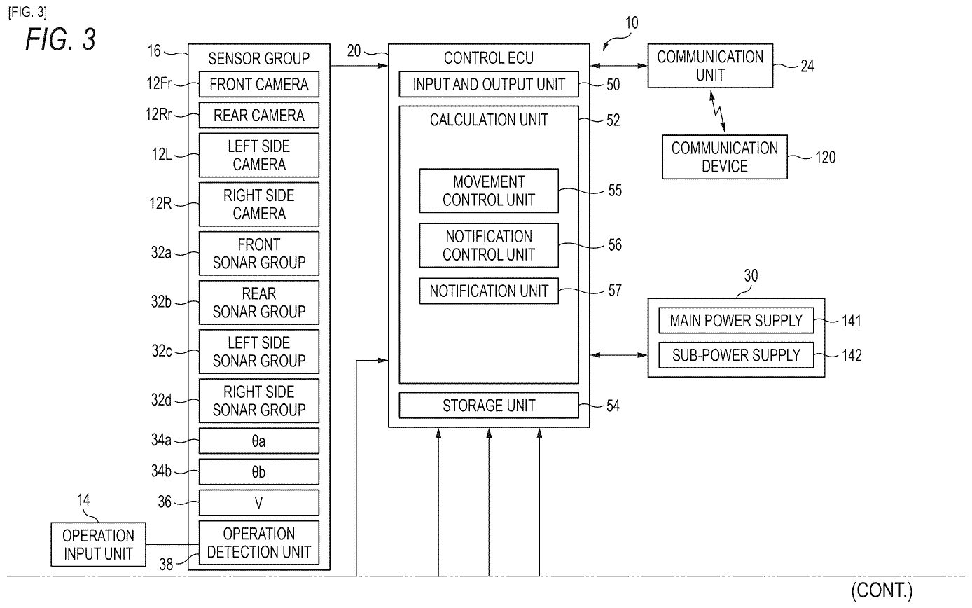

Hereinafter, an embodiment of a control device, a control method, and a control program of the present invention will be described with reference to the accompanying drawings. The drawings are viewed in directions of reference numerals. In order to simplify and clarify the description in the present specification or the like, a front-rear direction, a left-right direction, and an upper-lower direction are described according to directions viewed from a driver of a vehicle 10 illustrated in FIGS. 1 and 2. In the drawings, a front side of the vehicle 10 is illustrated as Fr, a rear side is illustrated as Rr, a left side is illustrated as L, a right side is illustrated as R, an upper side is illustrated as U, and a lower side is illustrated as D.

### Vehicle 10 Subjected to Movement Control by Control Device of Present Invention

FIG. 1 is a side view of the vehicle 10 subjected to movement control by the control device of the present invention. FIG. 2 is a top view of the vehicle 10 illustrated in FIG. 1. The vehicle 10 is an example of a moving object of the present invention.

The vehicle 10 is an automobile including a drive source (not illustrated) and wheels including drive wheels driven by power of the drive source and steerable steered wheels. In the present embodiment, the vehicle 10 is a four-wheeled automobile having a pair of left and right front wheels and a pair of left and right rear wheels. The drive source of the vehicle 10 is, for example, an electric motor. Note that the drive source of the vehicle 10 may be an internal combustion engine such as a gasoline engine or a diesel engine, or a combination of an electric motor and an internal combustion engine. The drive source of the vehicle 10 may drive the pair of left and right front wheels, the pair of left and right rear wheels, or four wheels including the pair of left and right front wheels and the pair of left and right rear wheels. The front wheels and the rear wheels may all be steerable steered wheels, or the front wheels or the rear wheels may be steerable steered wheels.

The vehicle 10 further includes side mirrors 11L and 11R. The side mirrors 11L and 11R are mirrors (back mirrors) provided on outer sides of front seat doors of the vehicle 10 for the driver to check the rear side and rear lateral sides. The side mirrors 11L and 11R are fixed to a body of the vehicle 10 by rotation shafts extending in a vertical direction, and may be opened and closed by rotating about the rotation shafts.

The vehicle 10 further includes a front camera 12Fr, a rear camera 12Rr, a left side camera 12L, and a right side camera 12R. The front camera 12Fr is a digital camera that is provided on the front side of the vehicle 10 and captures an image of the front side of the vehicle 10. The rear camera 12Rr is a digital camera that is provided on the rear side of the vehicle 10 and captures an image of the rear side of the vehicle 10. The left side camera 12L is a digital camera that is provided on the left side mirror 11L of the vehicle 10 and captures an image of the left side of the vehicle 10. The right side camera 12R is a digital camera that is provided on the right side mirror 11R of the vehicle 10 and captures an image of the right side of the vehicle 10.

### Internal Configuration of Vehicle 10

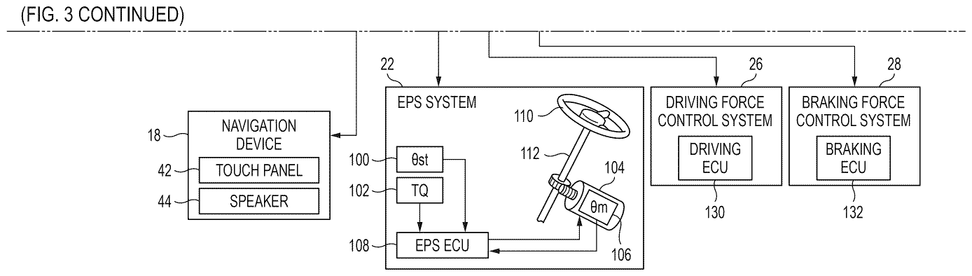

FIG. 3 is a block diagram illustrating an example of an internal configuration of the vehicle 10 illustrated in FIG. 1. As illustrated in FIG. 3, the vehicle 10 includes a sensor group 16, a navigation device 18, a control electronic control unit (ECU) 20, an electric power steering (EPS) system 22, and a communication unit 24. The vehicle 10 further includes a driving force control system 26, a braking force control system 28, and a power supply 30.

The sensor group 16 acquires various detection values used for control by the control ECU 20. The sensor group 16 includes the front camera 12Fr, the rear camera 12Rr, the left side camera 12L, and the right side camera 12R. The sensor group 16 also includes a front sonar group 32a, a rear sonar group 32b, a left side sonar group 32c, and a right side sonar group 32d. The sensor group 16 includes wheel sensors 34a and 34b, a vehicle speed sensor 36, and an operation detection unit 38. The sensor group 16 may include a radar.

The front camera 12Fr, the rear camera 12Rr, the left side camera 12L, and the right side camera 12R acquire recognition data (for example, peripheral images) for recognizing an external environment of the vehicle 10 by capturing images of a periphery of the vehicle 10. The peripheral images captured by the front camera 12Fr, the rear camera 12Rr, the left side camera 12L, and the right side camera 12R are referred to as a front image, a rear image, a left side image, and a right side image, respectively. An image constituted by the left side image and the right side image may be referred to as a side image.

The front sonar group 32a, the rear sonar group 32b, the left side sonar group 32c, and the right side sonar group 32d emit sound waves to the periphery of the vehicle 10, and receive reflected sounds from other objects. The front sonar group 32a includes, for example, four sonars. The sonars that constitute the front sonar group 32a are respectively provided on an obliquely left front side, a front left side, a front right side, and an obliquely right front side of the vehicle 10. The rear sonar group 32b includes, for example, four sonars. The sonars that constitute the rear sonar group 32b are respectively provided on an obliquely left rear side, a rear left side, a rear right side, and an obliquely right rear side of the vehicle 10. The left side sonar group 32c includes, for example, two sonars. The sonars that constitute the left side sonar group 32c are provided at a left side front portion and a left side rear portion of the vehicle 10, respectively. The right side sonar group 32d includes, for example, two sonars. The sonars that constitute the right side sonar group 32d are provided at a right side front portion and a right side rear portion of the vehicle 10, respectively.

The wheel sensors 34a and 34b detect rotation angles of the wheels of the vehicle 10. The wheel sensors 34a and 34b may be implemented by angle sensors or displacement sensors. The wheel sensors 34a and 34b output detection pulses each time the wheels rotate by a predetermined angle. The detection pulses output from the wheel sensors 34a and 34b are used to calculate rotation angles and rotation speeds of the wheels. A movement distance of the vehicle 10 is calculated based on the rotation angles of the wheels. The wheel sensor 34a detects, for example, a rotation angle θa of the left rear wheel. The wheel sensor 34b detects, for example, a rotation angle θb of the right rear wheel.

The vehicle speed sensor 36 detects a speed of a vehicle body of the vehicle 10, that is, a vehicle speed V, and outputs the detected vehicle speed V to the control ECU 20. The vehicle speed sensor 36 detects the vehicle speed V based on, for example, rotation of a countershaft of a transmission.

The operation detection unit 38 detects an operation content of a user performed using an operation input unit 14, and outputs the detected operation content to the control ECU 20. The operation input unit 14 includes various user interfaces such as a side mirror switch that switches between opened and closed states of the side mirrors 11L and 11R, and a shift lever (a selector lever or a selector).

The navigation device 18 detects a current position of the vehicle 10 using, for example, a global positioning system (GPS), and guides the user along a route to a destination. The navigation device 18 includes a storage device (not illustrated) including a map information database.

The navigation device 18 includes a touch panel 42 and a speaker 44. The touch panel 42 functions as an input device and a display device of the control ECU 20. The speaker 44 outputs various types of guidance information to the user of the vehicle 10 by voice.

The touch panel 42 enables input of various commands to the control ECU 20. For example, the user may input a command related to movement assistance of the vehicle 10 via the touch panel 42. The movement assistance includes parking assistance and exiting assistance of the vehicle 10. The touch panel 42 displays various screens related to control contents of the control ECU 20. For example, the touch panel 42 displays a screen related to the movement assistance of the vehicle 10. Specifically, the touch panel 42 displays a parking assistance button for requesting parking assistance of the vehicle 10 and an exiting assistance button for requesting exiting assistance. The parking assistance button includes an automated parking button for requesting parking by automatic steering of the control ECU 20, and a support parking button for requesting support while parking the vehicle by an operation of the driver. The exiting assistance button includes an automated exiting button for requesting exiting by the automatic steering of the control ECU 20, and a support exiting button for requesting support while exiting by an operation of the driver. Note that components other than the touch panel 42, for example, a smartphone or a tablet terminal may also be used as the input device or the display device.

The power supply 30 includes a main power supply 141 and a sub-power supply 142. The main power supply 141 is a power supply (secondary power supply) that supplies electric power to an electronic device installed in the vehicle 10 when the vehicle 10 is normally traveling and when the vehicle 10 is parked or exits. The sub-power supply 142 is a power supply (auxiliary power supply) that supplies electric power to vehicle stability assist (VSA) and electric parking brake (EPB) that decelerate or stop the vehicle 10 when the main power supply 141 fails. The sub-power supply 142 is used to operate fail-safe by operating VSA and EPB. The main power supply 141 is, for example, a lithium ion battery, a nickel-metal hydride battery, or a lead-acid battery. The sub-power supply 142 is, for example, a capacitor (electric double-layer capacitor). The power supply 30 is connected to the control ECU 20.

The control ECU 20 includes an input and output unit 50, a calculation unit 52, and a storage unit 54. The calculation unit 52 is implemented by, for example, a central processing unit (CPU). The calculation unit 52 executes various types of control by controlling units based on a program stored in the storage unit 54. Further, the calculation unit 52 receives and outputs signals from and to units connected to the control ECU 20 via the input and output unit 50. The control ECU 20 or the calculation unit 52, or a combination of the above with the communication unit 24, is an example of the control device of the present invention.

The calculation unit 52 includes a movement control unit 55 that performs movement control of the vehicle 10, a notification control unit 56 that can execute notifications from the vehicle 10, and a notification unit 57 that notifies the user of information about the movement control.

The movement control unit 55 performs automated parking assistance and automated exiting assistance of the vehicle 10 through automatic steering in which a steering 110 is automatically operated under control of the movement control unit 55. In the automated parking assistance and the automated exiting assistance, an accelerator pedal (not illustrated), a brake pedal (not illustrated), and the operation input unit 14 are automatically operated. The movement control unit 55 performs support parking assistance and support exiting assistance when the driver operates the accelerator pedal, the brake pedal, and the operation input unit 14 to manually park the vehicle 10 and manually cause the vehicle 10 to exit.

For example, the movement control unit 55 performs the movement control for executing movement of the vehicle 10 based on the recognition data of the external environment of the vehicle 10 acquired by the front camera 12Fr, the rear camera 12Rr, the left side camera 12L, and the right side camera 12R, and a parking space specified by the user. The movement control includes parking control for causing the vehicle 10 to perform automated parking in a predetermined parking space and exiting control for causing the vehicle 10 to perform automated exiting from the predetermined parking space to a target movement position. The movement control unit 55 executes the parking control and the exiting control according to instruction signals input from the outside via the input and output unit 50. The input from the outside includes an input by wireless communication from an information terminal or the like carried by the user of the vehicle 10. The movement control unit SS transmits information related to the parking control and the exiting control to an external information terminal via the input and output unit 50.

The notification control unit 56 is capable of executing a first notification, which is one mode of a notification from the vehicle 10, and a second notification from the vehicle 10 which is a mode different from the first notification. The notification from the vehicle 10 is a notification in a mode of being conveyed to people around the vehicle 10. The notification control unit 56 executes the first notification when an instruction for the movement control is received, and executes the second notification after executing the first notification, and then performs the movement control of the vehicle 10. The instruction for the movement control is, for example, an instruction from a user who instructs automatic movement of the vehicle 10. The first notification is, for example, a notification notifying execution preparation (execution plan) of movement control of the vehicle 10. The second notification is, for example, a notification notifying execution of movement control of the vehicle 10.

The notification control unit 56 executes the first notification in a case where execution of the movement control based on the instruction becomes possible, and executes the second notification at least either at a start of the movement control or during the execution of the movement control. The case where execution of the movement control based on the instruction becomes possible refers to a case where the user who gives the instruction makes a confirmation and the vehicle 10 is started. The user who gives the instruction making a confirmation means that, for example, a disclaimer is agreed by a specific operation executed by the user during automated parking control or automated exiting control of the vehicle 10. The vehicle 10 being started means that an ignition of the vehicle 10 is turned on. The case where execution of the movement control becomes possible may refer to, for example, a period from the operation of disclaimer agreement to immediately before an operation of selecting a parking or exiting direction of the vehicle 10 is received. The second notification is not limited to being executed at the start of the movement control, and may be started, for example, before the movement control is started. Before the movement control is started includes, for example, when the parking or exiting direction of the vehicle 10 is determined, and when the parking or exiting direction of the vehicle 10 is determined and the vehicle 10 is waiting for a next specific operation. During the execution of the movement control includes, for example, during the vehicle 10 is moving while a specific operation is being performed.

The second notification is, for example, a notification having a notification intensity higher than that of the first notification. Higher notification intensity means, for example, a louder volume when notifying by voice, and a brighter light, more light sources, or a more noticeable color of light when notifying by light. The noticeable color may be, for example, a warning color (danger color). When the notification is provided by a voice message, the voice message may be, for example, a voice with a strong tone. For example, as a type of notification that attracts attention, the first notification may be provided by light, and the second notification may be provided by sound that attracts more attention than light. As an example of changing the number of types of the notification, the first notification may be provided by light, and the second notification may be provided by light and sound.

The first notification is, for example, a notification by turning on a first lighting device of the vehicle 10, and the second notification is a notification that combines the turning on of the first lighting device with turning on of a second lighting device of the vehicle 10 that is different from the first lighting device. The first lighting device is, for example, a lighting device other than a headlamp and a hazard lamp of the vehicle 10. The second lighting device is, for example, a headlamp or a hazard lamp, or both the lighting devices.

The first notification may be a notification by turning on a lighting device of the vehicle 10, and the second notification may be a notification that combines turning on the lighting device with a different type of method from turning on the lighting device. The different type of method from turning on the lighting device includes, for example, outputting sound (warning sound or message), displaying texts or images, and projecting texts or images. The texts and images are displayed, for example, by a display device provided in the vehicle 10 in a manner of being capable of displaying the texts and images toward the outside of the vehicle 10. The texts and images are projected, for example, by a projection device provided in the vehicle 10 in a manner of being capable of projecting the texts and images toward the outside of the vehicle 10. The projection may be, for example, projection onto a window glass of the vehicle 10 or projection onto a road surface around the vehicle 10. Projection onto the window glass may be achieved, for example, by using a head-up display.

When a brightness around the vehicle 10 satisfies a predetermined condition, the notification control unit 56 executes the first notification by turning on a daytime running light installed on the vehicle 10, and when the brightness around the vehicle 10 does not satisfy the predetermined condition, the notification control unit 56 executes the first notification by turning on a lighting device of the vehicle 10 other than the daytime running light. The predetermined condition is that the brightness around the vehicle 10 is equal to or greater than a predetermined value. The lighting device of the vehicle 10 other than the daytime running light includes, for example, a position lamp and a fog lamp.

The notification control unit 56 executes the first notification when an instruction for movement control is received from an information terminal through communication with the information terminal portable by the user of the vehicle 10, and executes the second notification after executing the first notification. The case where an instruction for movement control is received from the information terminal refers to, for example, a case where a disclaimer agreement is made by the user operating the information terminal during automated parking control or automated exiting control of the vehicle 10. The notification control unit 56 executes the first notification when driver confirmation for the movement control is made, and executes the second notification when a movement direction of the movement control is confirmed. As described above, driver confirmation for the movement control refers to, for example, a case where a disclaimer agreement is made by the user operating the information terminal during automated parking control or automated exiting control. The notification control unit 56 may, for example, set the first notification as a notification only from the vehicle 10, and set the second notification as a notification that combines the notification from the vehicle 10 (first notification) with a notification from the information terminal.

When the second notification by the notification control unit 56 is a notification by turning on the headlamp provided in the vehicle 10, the movement control unit 55 performs restriction on the movement control of the vehicle 10 when an operation unit that controls a lighting state of the headlamp is in a state of instructing a certain operation of the headlamp. The state of instructing a certain operation of the headlamp is a state of instructing an operation other than an automatic operation of the headlamp. The state of instructing an operation other than the automatic operation includes, for example, a state of instructing to turn off the headlamp, and a state of instructing to turn on a high beam of the headlamp. In other words, the state of instructing a certain operation of the headlamp is a state in which the second notification cannot be provided using the headlamp since the state of the headlamp is fixed by a setting of the user, and if the movement control is executed normally, people around the vehicle cannot be notified. The restriction on the movement control of the vehicle 10 includes, for example, prohibiting execution of the movement control, restricting a movement speed in the movement control, and restricting a movement distance in the movement control.

When the movement control unit 55 performs the restriction on the movement control, the notification unit 57 notifies the user of an operation for releasing the restriction on the movement control. The operation for releasing the restriction on the movement control includes, for example, an operation of releasing an off position when an operation unit of the headlamp is set to the off position for turning off the headlamp, and an operation of releasing a high beam position when the operation unit of the headlamp is set to the high beam position for setting the headlamp to a high beam state. The notification unit 57 provides the notification by, for example, displaying a message such as “please set headlamp to auto mode” in text on the touch panel 42, or outputting the message by sound from the speaker 44.

The EPS system 22 includes a steering angle sensor 100, a torque sensor 102, an EPS motor 104, a resolver 106, and an EPS ECU 108. The steering angle sensor 100 detects a steering angle Ost of the steering 110. The torque sensor 102 detects a torque TQ applied to the steering 110.

The EPS motor 104 applies a driving force or a reaction force to a steering column 112 coupled to the steering 110, thereby enabling the occupant to perform operation assistance of the steering 110 and automatic steering during the parking assistance. The resolver 106 detects a rotation angle Om of the EPS motor 104. The EPS ECU 108 controls the entire EPS system 22. The EPS ECU 108 includes an input and output unit (not illustrated), a calculation unit (not illustrated), and a storage unit (not illustrated).

The communication unit 24 enables wireless communication with the other communication device 120. The other communication device 120 is a base station, a communication device of another vehicle, or an information terminal such as a smartphone or a tablet terminal portable by the user of the vehicle 10. For example, the communication unit 24 includes an ultra wide band (UWB, registered trademark) interface for performing UWB communication with an information terminal. The information terminal will be described later.

The driving force control system 26 includes a driving ECU 130. The driving force control system 26 executes driving force control of the vehicle 10. The driving ECU 130 controls a driving force of the vehicle 10 by controlling an engine or the like (not illustrated) based on an operation performed by the user on the accelerator pedal (not illustrated).

The braking force control system 28 includes a braking ECU 132. The braking force control system 28 executes braking force control of the vehicle 10. The braking ECU 132 controls a braking force of the vehicle 10 by controlling a braking mechanism or the like (not illustrated) based on an operation performed by the user on the brake pedal (not illustrated).

### Hardware Configuration of Information Terminal

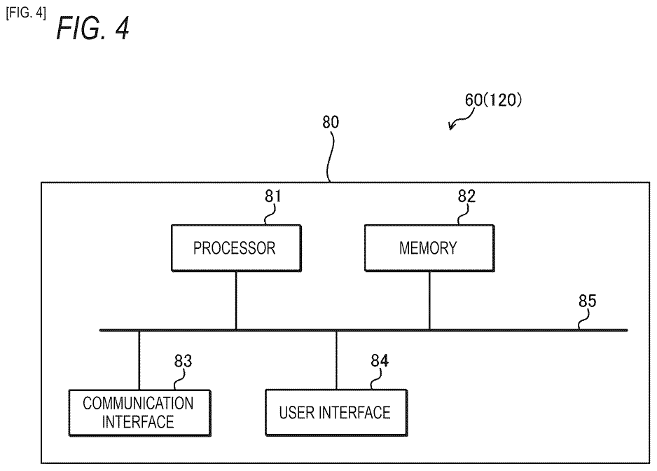

FIG. 4 is a diagram illustrating an example of a hardware configuration of an information terminal 60. Hardware of the information terminal 60 may be implemented by, for example, an information processing device 80 illustrated in FIG. 4. The information processing device 80 includes a processor 81, a memory 82, a communication interface 83, and a user interface 84. The processor 81, the memory 82, the communication interface 83, and the user interface 84 are connected by, for example, a bus 85.

The processor 81 is circuitry that performs signal processing, and is, for example, a central processing unit (CPU) that controls the entire information processing device 80. The processor 81 may be implemented by another digital circuit such as a field programmable gate array (FPGA) or a digital signal processor (DSP). The processor 81 may also be implemented by combining a plurality of digital circuits.

The memory 82 includes, for example, a main memory and an auxiliary memory. The main memory is, for example, a random access memory (RAM). The main memory is used as a work area of the processor 81.

The auxiliary memory is a non-volatile memory such as a magnetic disk, an optical disk, or a flash memory. The auxiliary memory stores various programs for operating the information processing device 80. The programs stored in the auxiliary memory are loaded into the main memory and executed by the processor 81.

The auxiliary memory may include a portable memory removable from the information processing device 80. Examples of the portable memory include a universal serial bus (USB) flash drive, a memory card such as a secure digital (SD) memory card, and an external hard disk drive.

The communication interface 83 is a communication interface that performs wireless communication with the outside of the information processing device 80 (for example, the communication unit 24 of the vehicle 10). For example, the communication interface 83 includes a UWB interface for performing UWB communication with the vehicle 10. The communication interface 83 is controlled by the processor 81.

The user interface 84 includes, for example, an input device that receives an operation input from the user and an output device that outputs information to the user. The input device may be implemented by, for example, a touch panel. The output device may be implemented by, for example, a display and a speaker. The user interface 84 is controlled by the processor 81.

The processor 81 performs the movement control for giving an instruction to move the vehicle 10. For example, the processor 81 performs the movement control on the vehicle 10 based on a specific operation of the user on the terminal screen of the information terminal 60. The movement control includes, for example, the parking control for causing the vehicle 10 to perform automated parking in a predetermined parking space and the exiting control for causing the vehicle 10 to perform automated exiting from the predetermined parking space to a target movement position. The specific operation includes, for example, a slide operation for moving the vehicle 10, and a tap operation for reserving parking and exit plans. The slide operation includes a continuous position instruction operation (for example, swiping operation), a rotation instruction operation in a predetermined rotation direction (for example, rotation swiping operation), and the like. Further, the processor 81 performs control of generating a guidance image for prompting the user M to perform the instruction operation on the terminal screen of the information terminal 60 and causing the terminal screen to display the generated guidance image.

The processor 81 transmits to the vehicle 10 a parking instruction for causing the vehicle 10 to perform automated parking and an exiting instruction for causing the vehicle 10 to perform automated exiting based on the specific operation on the terminal screen of the information terminal 60. An application configured to perform movement control on the vehicle 10 by transmitting and receiving information about the movement control of the vehicle 10 to and from the vehicle 10 is installed in the information terminal 60.

### Control by Information Terminal 60

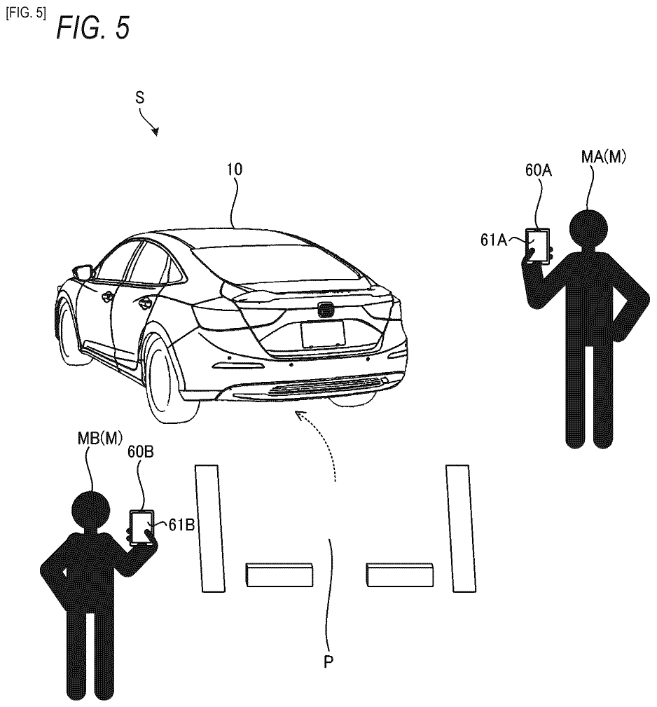

FIG. 5 is a diagram illustrating an example of movement control of the vehicle 10 from outside the vehicle 10 using the information terminal 60. Users MA and MB of the vehicle 10 control a movement instruction for causing the vehicle 10 to perform automated exiting from a parking space P from outside the vehicle 10 using an information terminal 60A carried by the user MA or an information terminal 60B carried by the user MB. The control on the movement instruction includes, for example, control on an exiting instruction for causing the vehicle 10 to perform automated exiting from the parking space P and control on a parking instruction for causing the vehicle 10 to perform automated parking in the parking space P. The example illustrated in FIG. 5 shows how the control on the exiting instruction for the vehicle 10 is performed.

When the users MA and MB touch terminal screens 61A and 61B of the information terminals 60A and 60B, respectively, the information terminals 60A and 60B transmit an instruction signal instructing automated exiting of the vehicle 10 to the vehicle 10 via wireless communication. Examples of the wireless communication with the vehicle 10 include UWB, Bluetooth low energy (BLE: registered trademark), and near field communication (NFC: registered trademark). The vehicle 10 receives the instruction signals transmitted from the information terminals 60A and 60B through the communication unit 24. The movement control unit 55 of the vehicle 10 performs automated exiting control of the vehicle 10 according to the received instruction signals.

### Movement Control by Calculation Unit 52

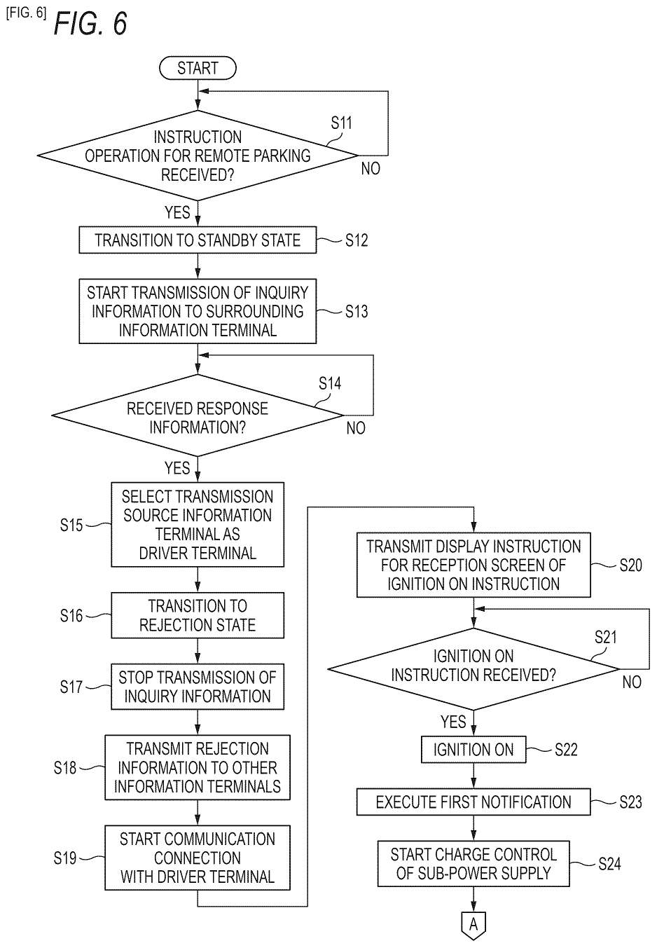

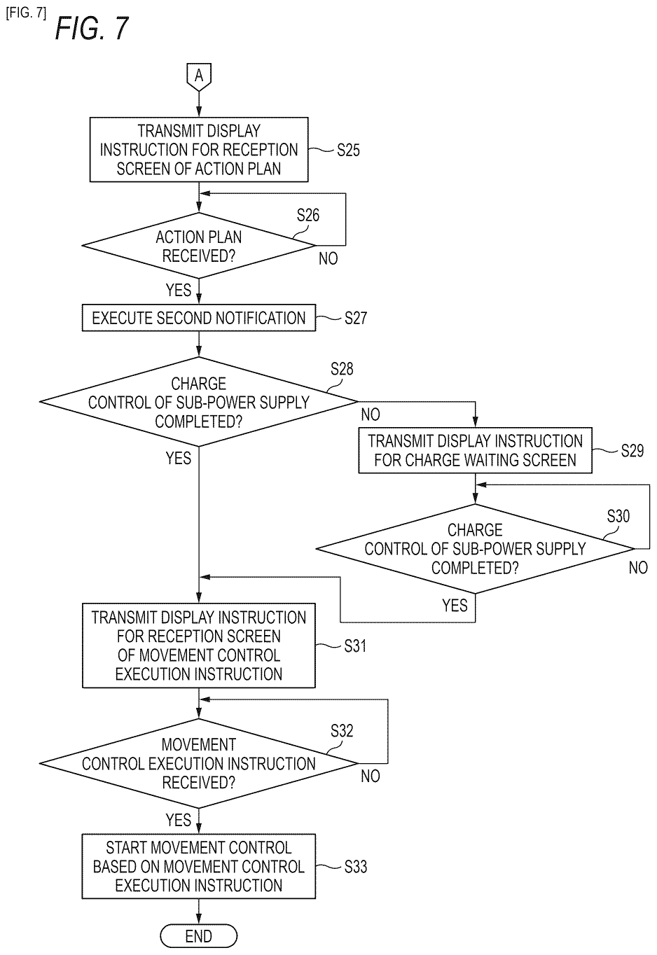

Next, the movement control of the vehicle 10 by the calculation unit 52 of the vehicle 10 will be described with reference to FIGS. 6 and 7.

FIG. 6 is a flowchart illustrating the automated exiting control of the vehicle 10 by the calculation unit 52. FIG. 7 is a flowchart illustrating the automated exiting control following the processing of FIG. 6. Note that the present automated exiting control is executed, for example, in a situation as shown in FIG. 5, in which a user M (MA, MB) is attempting to cause the vehicle 10 to perform automated exiting from the parking space P using the information terminal 60 (60A, 60B).

First, the movement control unit 55 of the calculation unit 52 determines whether a remote parking instruction operation is received (step S11). The instruction operation for remote parking is an operation of setting a state of the vehicle 10 to a state in which the vehicle 10 can be caused to exit by the automated exiting control. The instruction operation is received by touching the automated exiting button (not illustrated) by the user M in the vehicle 10. The automated exiting button may be, for example, a touch button displayed on the touch panel 42 of the navigation device 18, or a mechanical vehicle switch.

In step S11, if an instruction operation for remote parking is not received (step S11; No), the movement control unit 55 repeats the processing of step S11 and waits until the instruction operation for remote parking is received.

In step S11, when an instruction operation for remote parking is received (step S11: Yes), the movement control unit 55 transitions to a standby state in which a signal can be received from the external information terminal 60 (step S12). In this way, the movement control unit 55 is enabled to receive signals from the information terminals 60A and 60B of the users MA and MB outside the vehicle 10, for example. Therefore, the users MA and MB are able to cause the vehicle 10 to perform automated exiting using the information terminals 60A and 60B.

Next, the movement control unit 55 starts transmitting inquiry information regarding the automated exiting to the information terminal 60 of the user M around the vehicle 10 (step S13). The information terminal 60 around the vehicle 10 is, for example, an information terminal whose communication quality with the communication unit 24 of the vehicle 10 is equal to or higher than a certain level. Specifically, the information terminal of the user M within 5 m to 10 m distance of the vehicle 10 becomes the information terminal 60 around the vehicle 10. The inquiry information regarding the automated exiting is, for example, information for inquiring of the user M whether to agree to cautions stipulated regarding automated exiting. Alternatively, the inquiry information may be information simply for inquiring whether to execute the automated exiting.

Next, the movement control unit 55 determines whether response information to the inquiry information transmitted in step S13 is received from the information terminal 60 (step S14). The response information is, for example, information on a response of agreeing to the cautions regarding the inquired automated exiting. Alternatively, the response information may simply be information on a response of executing the automated exiting.

In step S14, if no response information is received (step S14: No), the movement control unit 55 repeats the processing of step S14 and waits until response information is received.

In step S14, when the response information is received (step S14: Yes), the movement control unit 55 selects the information terminal 60 that transmits the response information as a driver terminal (step S15). The information terminal 60 that transmits the response information is the information terminal 60 that transmits the response information first received after the movement control unit 55 transmits the inquiry information. The driver terminal is the information terminal 60 that is permitted to control automated exiting of the vehicle 10. Here, the following description will be given on an assumption that the information terminal 60A carried by the user MA is selected as the driver terminal.

Next, the movement control unit 55 transitions to a rejection state of responding with a rejection to signals from terminals other than the driver terminal selected in step S15, that is, information terminals 60 other than the information terminal 60A of the user MA (step S16). As a result, the movement control unit 55 enters a state of responding with a rejection to the signal from, for example, the information terminal 60B carried by the user MB between the users MA and MB outside the vehicle 10. Therefore, the user MB is unable to cause the vehicle 10 to perform automated exiting using the information terminal 60B.

The movement control unit 55 stops the transmission of the inquiry information regarding the automated exiting to the information terminal 60 of the user M around the vehicle 10, which is started in step S13 (step S17). That is, since the information terminal 60A is confirmed as the driver terminal that controls the automated exiting of the vehicle 10, the movement control unit 55 stops transmitting the inquiry information regarding the automated exiting.

The movement control unit 55 transmits, to the information terminal 60 that is not selected as the driver terminal, for example, the information terminal 60B of the user MB, rejection information notifying that the signal from the information terminal 60B is not received (step S18). In other words, since the user M (information terminal 60) capable of controlling the automated exiting of the vehicle 10 is confirmed, the user MB (information terminal 60B) is notified that the automated exiting of the vehicle 10 cannot be performed by the information terminal 60B of the user MB.

Next, the movement control unit 55 starts a communication connection with the driver terminal, that is, a communication connection with the information terminal 60A carried by the user MA (step S19).

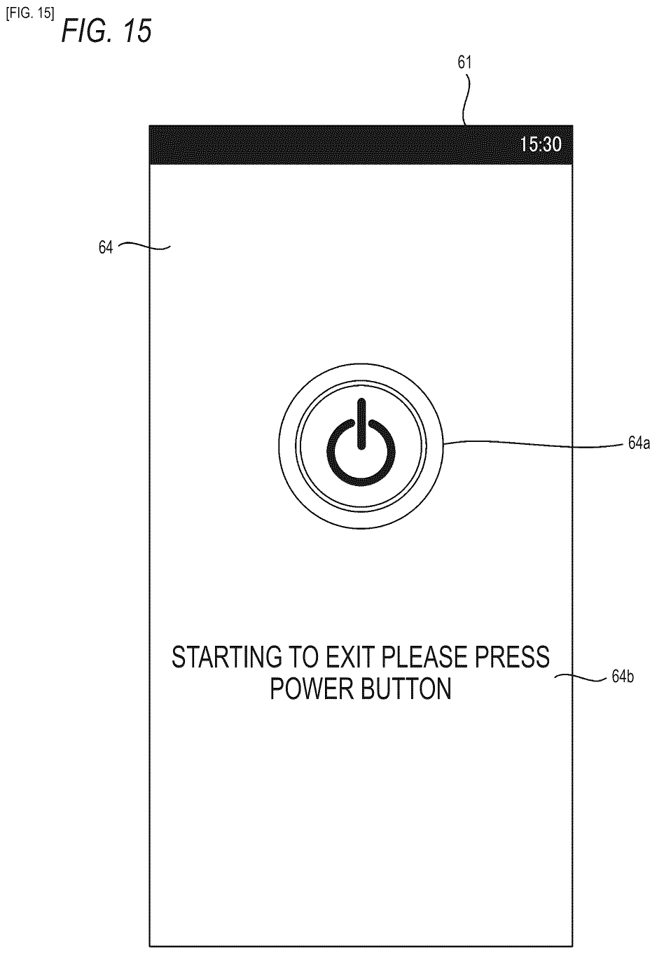

Next, in order to cause the terminal screen 61A of the information terminal 60A to display a reception screen of an ignition ON instruction for an operation to turn on the ignition of the vehicle 10, the movement control unit 55 transmits a display instruction to the information terminal 60A (step S20). Examples of the reception screen of the ignition ON instruction include a screen illustrated in FIG. 15.

Next, the movement control unit 55 determines whether the ignition ON instruction for turning on the ignition of the vehicle 10 is received from the information terminal 60A (step S21).

In step S21, if the ignition ON instruction is not received (step S21: No), the movement control unit 55 repeats the processing of step S21 until the ignition ON instruction is received. In step S21, if the ignition ON instruction is received (step S21: Yes), the movement control unit 55 turns on the ignition of the vehicle 10 (step S22).

Next, the notification control unit 56 of the calculation unit 52 executes the first notification from the vehicle 10 (step S23). In the present example, the notification control unit 56 executes the first notification when the information terminal 60A carried by the user MA is selected as the driver terminal and the ignition of the vehicle 10 is turned on. As described above, the first notification is, for example, a notification by turning on the position lamp. The first notification executed when the ignition is turned on may be, for example, a notification by lighting the position lamp once or several times, or a notification by keeping the lamp continuously lit, specifically, a notification that continues to light the lamp until the second notification is executed.

Next, the movement control unit 55 starts the charge control for charging the battery of the sub-power supply 142 of the vehicle 10 (step S24).

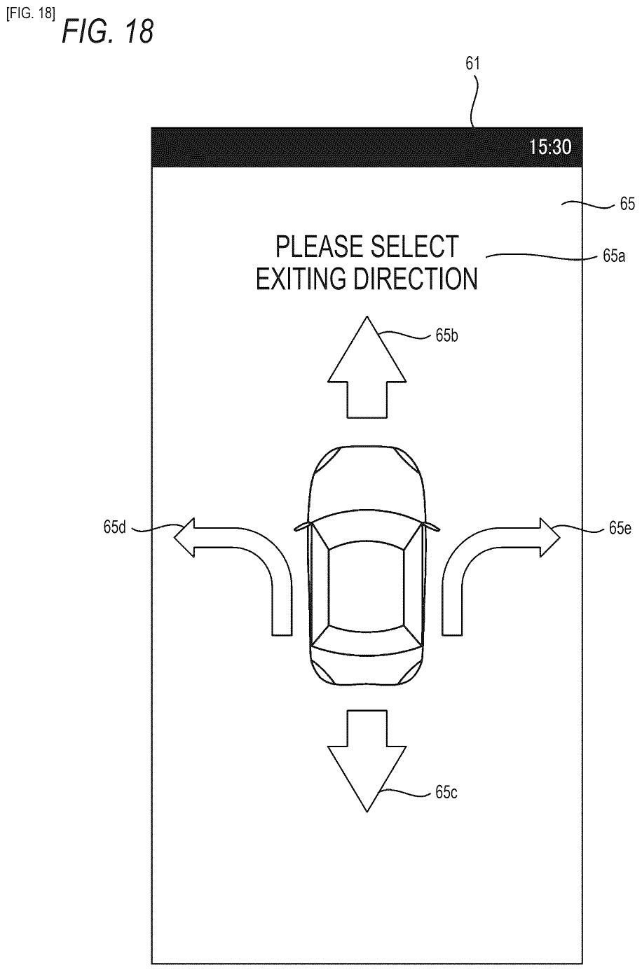

Next, proceeding to FIG. 7, in order to cause the terminal screen 61A of the information terminal 60A to display an action plan reception screen for allowing the user M to perform an input operation of an action plan of the vehicle 10, the movement control unit 55 transmits a display instruction to the information terminal 60A (step S25). Examples of the action plan reception screen include a screen illustrated in FIG. 18.

Next, the movement control unit 55 determines whether the action plan of the vehicle 10 is received from the information terminal 60A that transmits the display instruction in step S25 (step S26).

In step S26, if the action plan is not received (step S26: No), the movement control unit 55 repeats the processing of step S26 until the action plan is received.

In step S26, if the action plan is received (step S26: Yes), the notification control unit 56 executes the second notification by the vehicle 10 (step S27). In the present example, the notification control unit 56 executes the second notification when the exiting direction of the vehicle 10 is selected by operating the terminal screen 61A of the information terminal 60A. As described above, the second notification is, for example, a notification in a mode that combines the lighting of the position lamp (first notification) with the lighting of the headlamp. The second notification is, for example, a notification having a notification intensity higher than that of the first notification. The second notification executed after the selection of the exiting direction may be, for example, a notification by lighting the position lamp and the headlamp once or several times, or a notification by keeping the lamps continuously lit, specifically, a notification that continues to light the lamps even after the movement control is started.

Next, the movement control unit 55 determines whether the charge control of the sub-power supply 142 started in step S24 is completed (step S28).

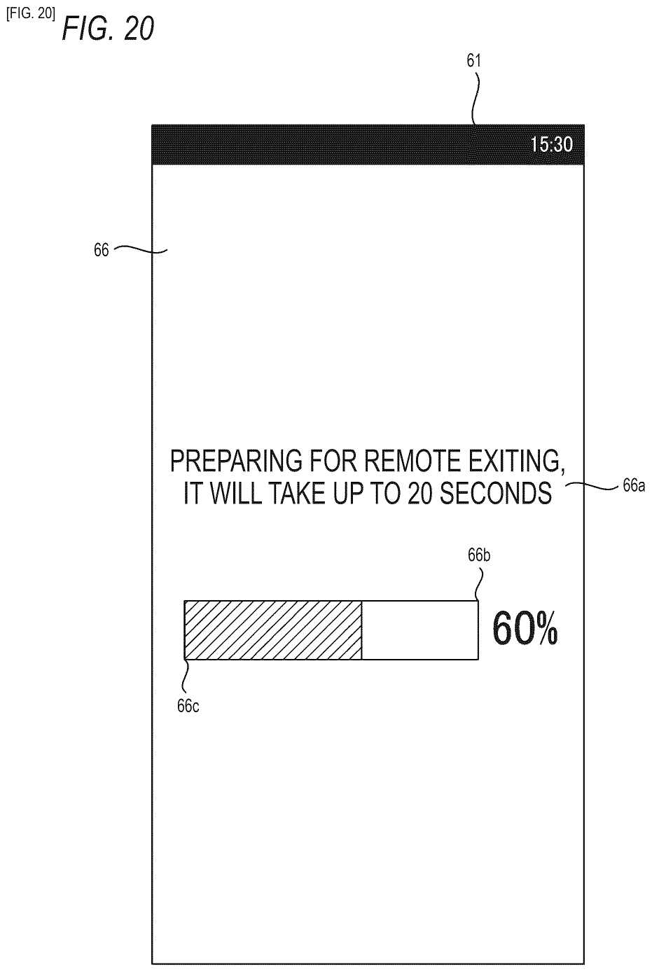

In step S28, if the charge control on the sub-power supply 142 is not completed (step S28: No), in order to cause the terminal screen 61A of the information terminal 60A to display a charge waiting screen for making the user M wait for charge completion of the sub-power supply 142, the movement control unit 55 transmits a display instruction to the information terminal 60A (step S29). Examples of the charge waiting screen include a screen illustrated in FIG. 20.

Next, the movement control unit 55 determines whether the charge control on the sub-power supply 142 is completed (step S30).

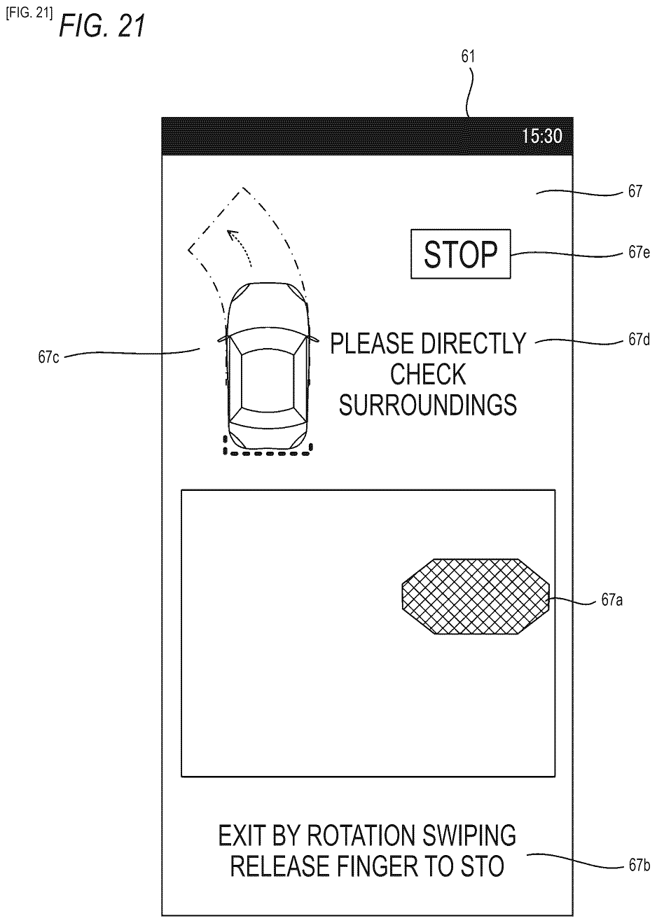

In step S30, if the charge control on the sub-power supply 142 is not completed (step S30: No), the movement control unit 55 repeats the processing of step S30 until the charge control is completed. In step S30, if the charge control on the sub-power supply 142 is completed (step S30: Yes), in order to cause the terminal screen 61A of the information terminal 60A to display a reception screen of a movement control execution instruction for allowing the user M to give an instruction of executing the movement control on the vehicle 10, the movement control unit 55 transmits a display instruction to the information terminal 60A (step S31). Examples of the reception screen for the movement control execution instruction include a screen illustrated in FIG. 21.

On the other hand, if it is determined in step S28 that the charge control on the sub-power supply 142 is completed (step S28: Yes), the movement control unit 55 also proceeds to step S31, and transmits the display instruction of the reception screen for the movement control execution instruction to the information terminal 60A.

Next, the movement control unit 55 determines whether the movement control execution instruction is received from the information terminal 60A that transmits the display instruction in step S31 (step S32).

In step S32, if no movement control execution instruction is received (step S32: No), the movement control unit 55 repeats the processing of step S32 until the movement control execution instruction is received. In step S32, if the movement control execution instruction is received (step S32: Yes), the movement control unit 55 starts the movement control on the vehicle 10 based on the movement control execution instruction (step S33).

As described above, the notification control unit 56 in the control device (calculation unit 52) of the vehicle 10 executes the first notification when an instruction for automated exiting control of the vehicle 10 is received and execution of the automated exiting control becomes possible, for example, when the information terminal 60A is selected as the driver terminal by the disclaimer agreement by the user MA and the ignition of the vehicle 10 is turned on, and after executing the first notification, executes the second notification when, for example, the exiting direction of the vehicle 10 is selected by operating the information terminal 60A. Therefore, it is possible to accurately notify the people around the vehicle 10 of a moving state in a stage at which the vehicle 10 is in during the automated exiting. In this way, the people around the vehicle 10 can be prevented from feeling anxious because they are unable to distinguish the moving state of the vehicle 10, and from feeling a sense of crisis since the vehicle 10 will enter a moving state without giving any notice. Therefore, it is possible to improve safety and usability for traffic participants.

The notification control unit 56 provides the second notification with a notification intensity higher than that of the first notification. In this way, it is possible to more accurately notify the people around the vehicle 10 of the moving state in a stage at which the vehicle 10 is in during the automated exiting.

### Control System Operation

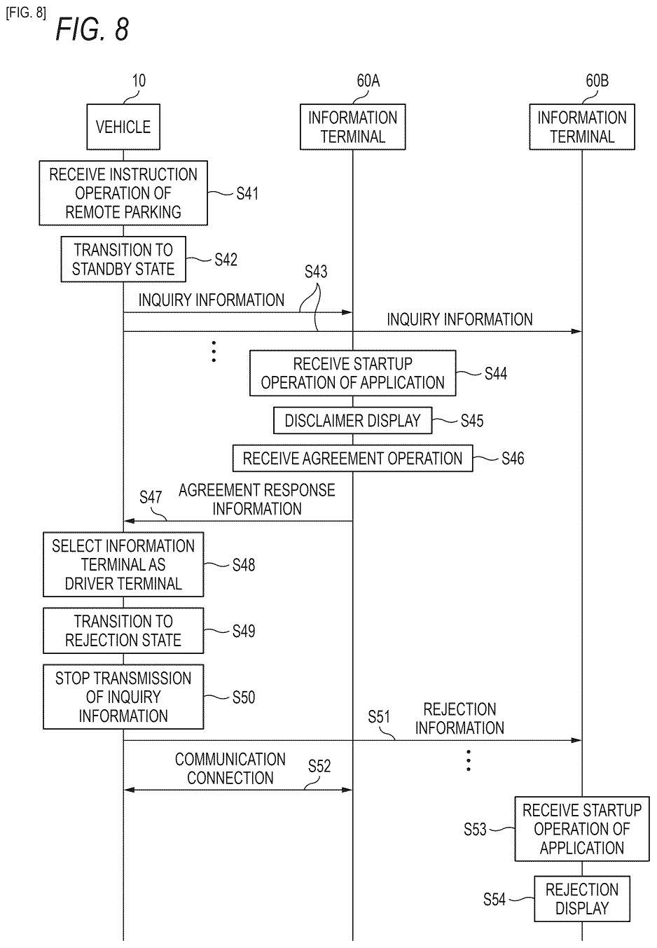

Next, an operation example of a control system S (see FIG. 5) constituted by the vehicle 10 that performs the automated exiting control and the information terminals 60A and 60B that perform the exiting instruction control will be described with reference to FIGS. 8 to 11. As described above, the situation in FIG. 5 is a situation in which the user M (MA, MB) is attempting to cause the vehicle 10 to perform automated exiting from the parking space P using the information terminal 60 (60A, 60B).

### First Operation Example

FIG. 8 is a sequence diagram illustrating a first operation example of the control system S. First, the vehicle 10 receives from the user M a remote parking instruction operation for causing the vehicle 10 parked in the parking space P to exit by the automated exiting control (step S41). The vehicle 10 transitions to a standby state of being capable of receiving a signal from the information terminal 60 (step S42). The vehicle 10 transmits the inquiry information regarding the automated exiting to, for example, the information terminal 60A carried by the user MA and the information terminal 60B carried by the user MB around the vehicle 10 (step S43).

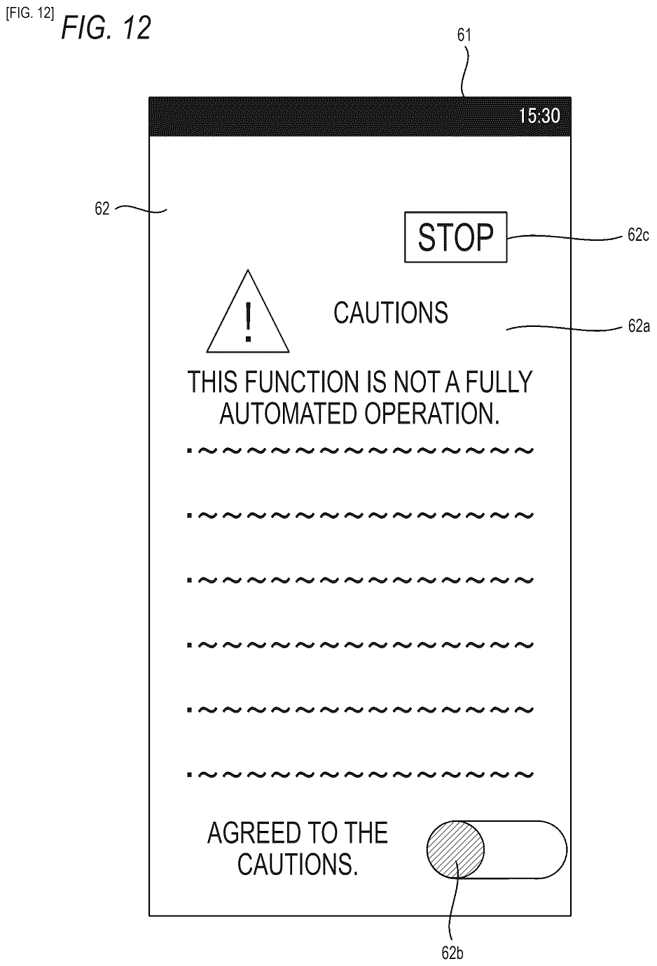

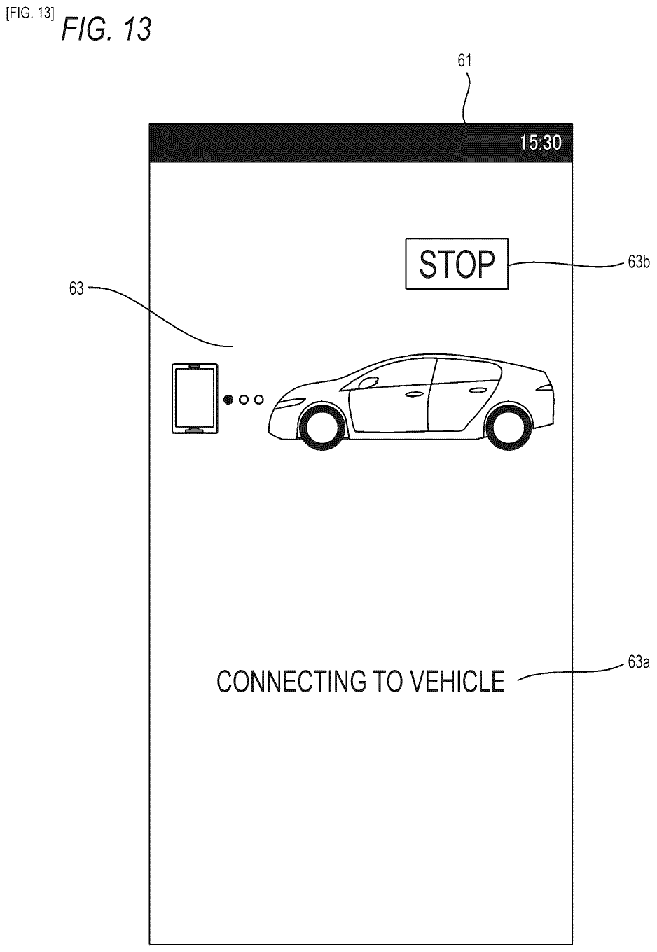

The information terminal 60A receives a startup operation by the user MA who starts the application for giving a movement instruction for the vehicle 10 (step S44). The information terminal 60A displays a disclaimer (cautions stipulated regarding the automated exiting) on the terminal screen 61A (step S45). Examples of the disclaimer screen include a screen illustrated in FIG. 12. The information terminal 60A receives an agreement operation by the user MA who agrees to the disclaimer (step S46). The information terminal 60A transmits the agreement response information on the user MA who agrees to the disclaimer to the vehicle 10 (step S47). Examples of a screen that is displayed when the agreement operation of the user MA is received include a screen shown in FIG. 13.

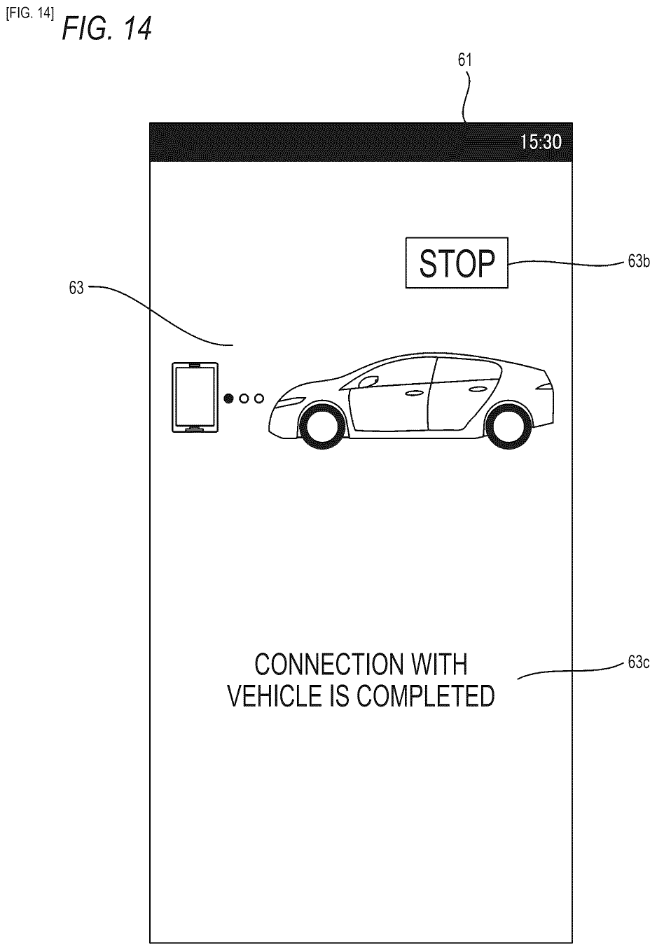

The vehicle 10 selects the information terminal that transmits the agreement response information first, in the present example, the information terminal 60A, as the driver terminal (step S48). The vehicle 10 transitions to a rejection state of rejecting reception of signals from the information terminal 60B of the user MB other than the information terminal 60A of the user MA selected as the driver terminal (step S49). The vehicle 10 stops transmitting the inquiry information regarding the automated exiting to the information terminal 60B (step S50). The vehicle 10 transmits, to the information terminal 60B that is not selected as the driver terminal, rejection information notifying that the signal from the information terminal 60B is not received (step S51). As a result, the information terminal 60A is in communication connection with the vehicle 10 as the driver terminal capable of giving an exiting instruction for automated exiting of the vehicle 10 (step S52). The vehicle 10 receives the exiting instruction from the driver terminal and executes the movement control. Examples of a screen that is displayed in communication connection include a screen illustrated in FIG. 14.

Then, after the rejection information is transmitted from the vehicle 10 to the information terminal 60B, for example, it is assumed that the information terminal 60B receives a startup operation by the user MB who starts an application for giving a movement instruction for the vehicle 10 (step S53). The information terminal 60B displays, on the terminal screen 61B, the rejection information notifying that the information terminal 60B is not selected as the driver terminal (step S54).

### Second Operation Example

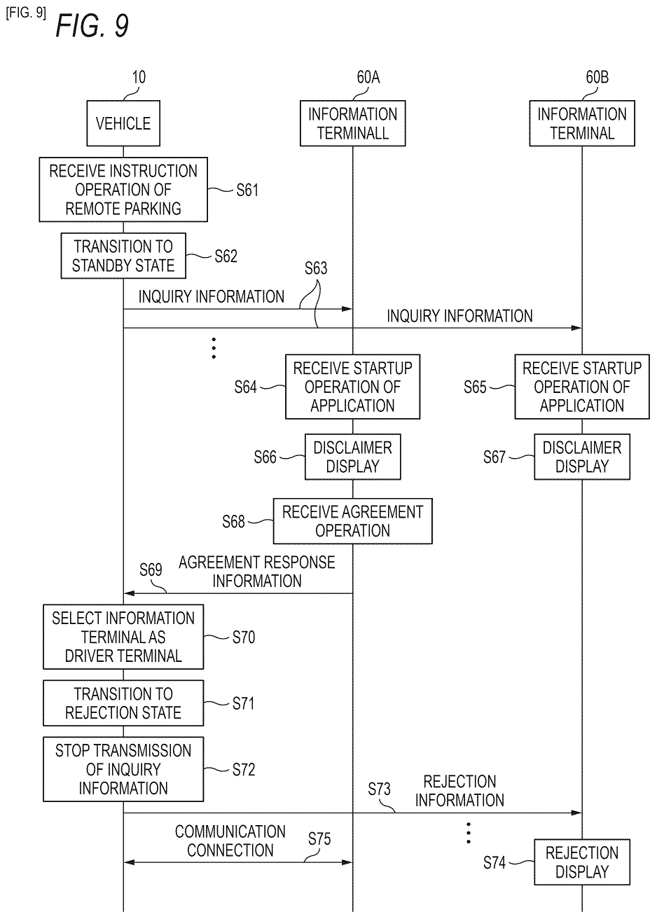

FIG. 9 is a sequence diagram illustrating a second operation example of the control system S. First, the vehicle 10 receives from the user M a remote parking instruction operation for causing the vehicle 10 parked in the parking space P to exit by the automated exiting control (step S61). The vehicle 10 transitions to a standby state of being capable of receiving a signal from the information terminal 60 (step S62). The vehicle 10 transmits the inquiry information regarding the automated exiting to, for example, the information terminal 60A carried by the user MA and the information terminal 60B carried by the user MB around the vehicle 10 (step S63).

The information terminal 60A receives a startup operation by the user MA who starts the application for giving a movement instruction for the vehicle 10 (step S64). The information terminal 60B receives a startup operation by the user MB who starts the application for giving a movement instruction for the vehicle 10 (step S65).

The information terminal 60A displays a disclaimer (cautions stipulated regarding the automated exiting) on the terminal screen 61A (step S66). The information terminal 60B displays the disclaimer on the terminal screen 61B (step S67). Examples of the disclaimer screen include a screen illustrated in FIG. 12.

The information terminal 60A receives an agreement operation by the user MA who agrees to the disclaimer (step S68). The information terminal 60A transmits the agreement response information on the user MA who agrees to the disclaimer to the vehicle 10 (step S69). Examples of a screen that is displayed when the agreement operation of the user MA is received include a screen shown in FIG. 13.

The vehicle 10 selects the information terminal 60A that transmits the agreement response information as the driver terminal (step S70). The vehicle 10 transitions to a rejection state of rejecting reception of signals from the information terminal 60B of the user MB other than the information terminal 60A of the user MA selected as the driver terminal (step S71). The vehicle 10 stops transmitting the inquiry information regarding the automated exiting to the information terminal 60B (step S72). The vehicle 10 transmits, to the information terminal 60B that is not selected as the driver terminal, rejection information notifying that the signal from the information terminal 60B is not received (step S73).

The information terminal 60B displays, on the terminal screen 61B, the rejection information notifying that the information terminal 60B is not selected as the driver terminal (step S74).

As a result, the information terminal 60A is in communication connection with the vehicle 10 as the driver terminal capable of giving an exiting instruction for automated exiting of the vehicle 10 (step S75). Examples of a screen that is displayed in communication connection include a screen illustrated in FIG. 14.

As described above, according to the first operation example and the second operation example of the control system S, when the inquiry information regarding the automated exiting is transmitted from the vehicle 10 to the information terminals 60A and 60B, the information terminal that first transmits the agreement response information to the vehicle 10 in response to the inquiry information, in the present example, the information terminal 60A, is selected as the driver terminal, and the rejection information is transmitted to the information terminal that does not transmit the agreement response information, in the example, the information terminal 60B. Therefore, the user MB of the information terminal 60B other than the driver terminal can recognize that another user becomes an instructing driver who gives an exiting instruction for the vehicle 10, thereby improving usability.

### Third Operation Example

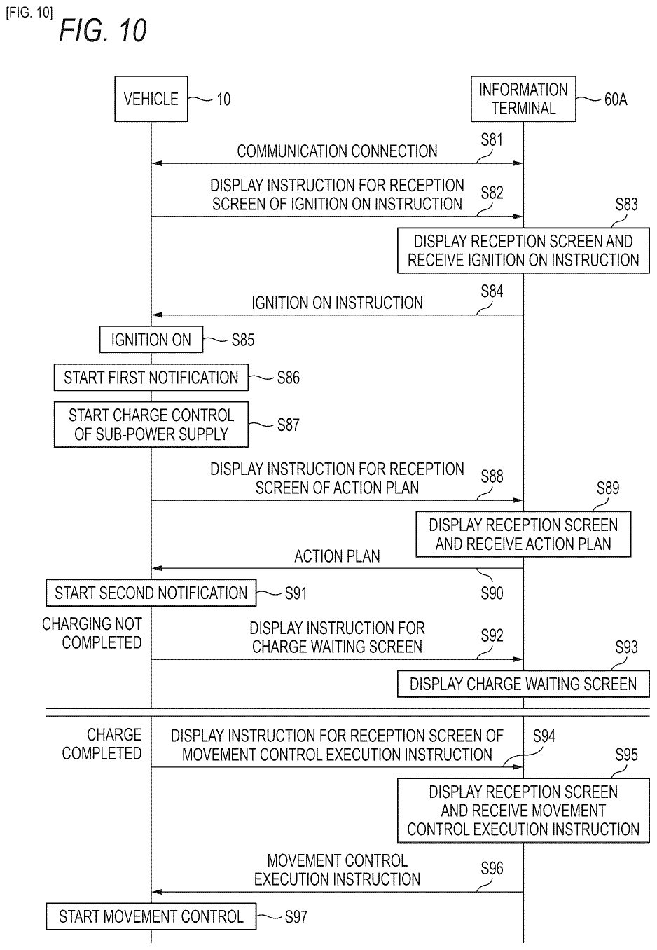

FIG. 10 is a sequence diagram illustrating a third operation example of the control system S. The third operation example is an operation example in which the exiting control of the vehicle 10 is performed by the information terminal 60A selected as the driver terminal and the vehicle 10.

The information terminal 60A receives the inquiry information regarding the automated exiting transmitted from the vehicle 10, and the information terminal 60A transmits the agreement response information to the vehicle 10, whereby the information terminal 60A is selected as the driver terminal, and the information terminal 60A and the vehicle 10 are in a connected state capable of communicating with each other (step S81). The above case corresponds to the state of step S52 in FIG. 8 or the state of step S75 in FIG. 9.

In order to cause the terminal screen 61A of the information terminal 60A to display a reception screen of an ignition ON instruction for an operation to turn on the ignition of the vehicle 10, the vehicle 10 in communication connection with the information terminal 60A transmits a display instruction to the information terminal 60A (step S82).

If the display instruction from the vehicle 10 is received in step S82, the information terminal 60A displays on the terminal screen 61A the reception screen of the ignition ON instruction, and receives the ignition ON instruction from the user MA on the reception screen (step S83). Examples of the reception screen of the ignition ON instruction include the screens illustrated in FIGS. 15 to 17. If the ON instruction is received from the user MA in step S83, the information terminal 60A transmits the ignition ON instruction for turning on the ignition to the vehicle 10 (step S84).

If the ignition ON instruction is received from the information terminal 60A in step S84, the vehicle 10 turns on the ignition of the vehicle 10 (step S85). When the ignition of the vehicle 10 is turned on, the vehicle 10 starts the first notification (step S86). In the present example, the vehicle 10 starts the first notification when the information terminal 60A of the user MA is selected as the driver terminal and the ignition of the vehicle 10 is turned on. As described above, the first notification is, for example, a notification by turning on the position lamp. The vehicle 10 starts the charge control for charging the battery of the sub-power supply 142 of the vehicle 10 (step S87). In order to cause the terminal screen 61A of the information terminal 60A to display an action plan reception screen for allowing the user MA to perform an input operation of the action plan of the vehicle 10, the vehicle 10 transmits a display instruction to the information terminal 60A (step S88).

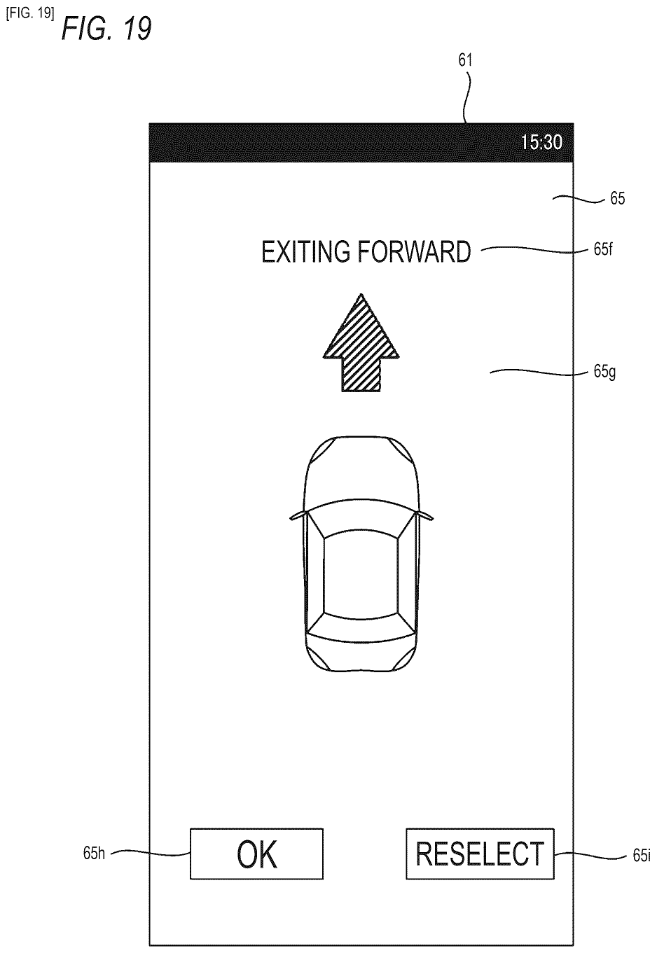

If the display instruction is received from the vehicle 10 in step S88, the information terminal 60A displays on the terminal screen 61A the action plan reception screen, and receives an action plan instruction from the user MA on the reception screen (step S89). Examples of the action plan reception screen include the screen illustrated in FIG. 18, and examples of the screen for receiving the action plan instruction include the screen illustrated in FIG. 19. Next, if the action plan instruction from the user MA is received in step S89, the information terminal 60A transmits the action plan to the vehicle 10 (step S90).

If the action plan from the information terminal 60A is received in step S90, the vehicle 10 starts the second notification from the vehicle 10 (step S91). In the present example, the vehicle 10 starts the second notification when the exiting direction of the vehicle 10 is selected by operating the terminal screen 61A of the information terminal 60A. As described above, the second notification is, for example, a notification in a mode that combines the lighting of the position lamp (first notification) with the lighting of the headlamp. The second notification is, for example, a notification having a notification intensity higher than that of the first notification. If the second notification is started, the vehicle 10 determines whether the charge control on the sub-power supply 142 started in step S87 is completed. In a case where the charge of the sub-power supply 142 is not yet completed, in order to cause the terminal screen 61A of the information terminal 60A to display the charge waiting screen for having the user MA wait for charging, a display instruction is transmitted to the information terminal 60A (step S92).

If the display instruction from the vehicle 10 is received in step S92, the information terminal 60A displays the charge waiting screen on the terminal screen 61A (step S93). Examples of the charge waiting screen include the screen illustrated in FIG. 20.

After waiting for charging for a predetermined period, in a case where the charge of the sub-power supply 142 started in step S87 is completed, in order to cause the terminal screen 61A of the information terminal 60A to display the reception screen of the movement control execution instruction for executing the movement control on the vehicle 10, the vehicle 10 transmits a display instruction to the information terminal 60A (step S94).

If the display instruction is received from the vehicle 10 in step S94, the information terminal 60A displays on the terminal screen 61A the reception screen of the movement control execution instruction, and receives the movement control execution instruction from the user MA on the reception screen (step S95). Examples of the reception screen for the movement control execution instruction include the screen illustrated in FIG. 21. If the movement control execution instruction from the user MA is received in step S95, the information terminal 60A transmits the movement control execution instruction for executing the movement control to the vehicle 10 (step S96).

When the movement control execution instruction from the information terminal 60A is received, the vehicle 10 starts the movement control of causing the vehicle 10 to perform automated exiting from the parking space P in accordance with the movement control execution instruction (step S97).

### Fourth Operation Example

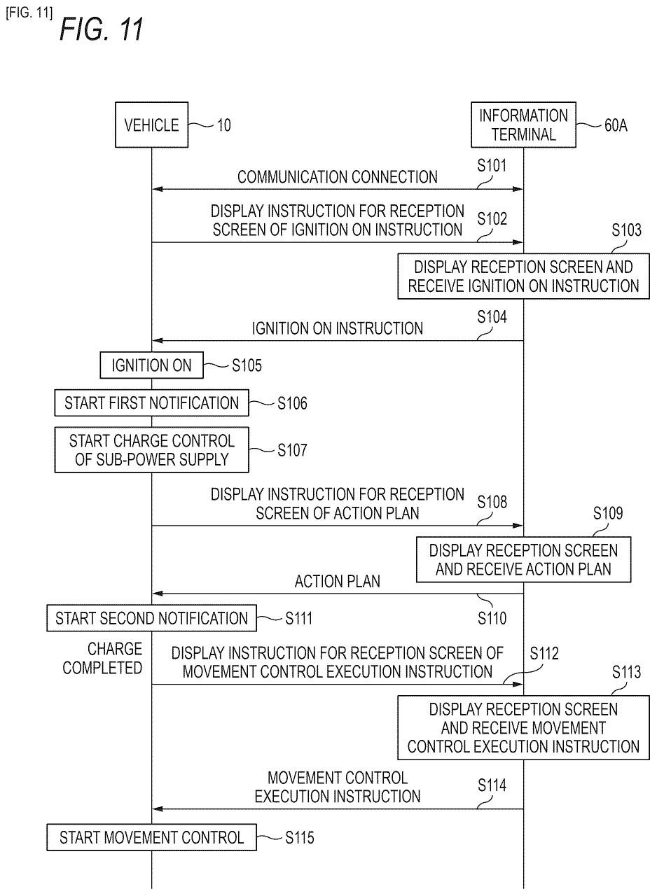

FIG. 11 is a sequence diagram illustrating a fourth operation example of the control system S. Similar to the third operation example described with reference to FIG. 10, the fourth operation example is an operation example in which the exiting control of the vehicle 10 is performed by the information terminal 60A selected as the driver terminal and the vehicle 10. However, in the third operation example, the charge of the sub-power supply 142 is not yet completed when the action plan is transmitted from the information terminal 60A to the vehicle 10, whereas the fourth operation example differs from the third operation example in that the charge of the sub-power supply 142 is completed when the action plan is transmitted.

As illustrated in FIG. 11, in the fourth operation example, processing from step S101 to step S111 is the same as the processing from step S81 to step S91 in the third operation example described with reference to FIG. 10. Therefore, the description of steps S101 to step SI11 will be omitted.

If the second notification is started in step S111, the vehicle 10 determines whether the charge control on the sub-power supply 142 started in step S107 is completed. In a case where the charge of the sub-power supply 142 is completed, in order to cause the terminal screen 61A of the information terminal 60A to display the reception screen of the movement control execution instruction for executing the movement control on the vehicle 10, a display instruction is transmitted to the information terminal 60A (step S112). That is, if the charge of the sub-power supply 142 is completed when the vehicle 10 receives the action plan from the information terminal 60A and starts the second notification, the vehicle 10 does not cause the terminal screen 61A of the information terminal 60A to display the charge waiting screen (see FIG. 20) for waiting for charge.

Note that the processing from step S113 to step S115 is similar to the processing from step S95 to step S97 in the third operation example illustrated in FIG. 10. Therefore, the description of step SI11 to step S115 will be omitted.

As described above, according to the third operation example and the fourth operation example of the control system S, the vehicle 10 receives the ignition ON instruction from the information terminal 60A that is in communication connection with the vehicle 10 as the driver terminal, and when the ignition is turned on in accordance with the instruction, the vehicle 10 starts the first notification, and after the first notification is started, when the action plan (exiting direction) of the vehicle 10 is received from the information terminal 60A, the vehicle 10 starts the second notification. Therefore, it is possible to accurately notify the people around the vehicle 10 of a moving state in a stage at which the vehicle 10 is in during the automated exiting. In this way, the people around the vehicle 10 can be prevented from feeling anxious because they are unable to distinguish the moving state of the vehicle 10, and from feeling a sense of crisis since the vehicle 10 will enter a moving state without giving any notice. Therefore, it is possible to improve safety and usability for traffic participants.

Even when a disclaimer agreement is made by an occupant (for example, the user MB) other than the driver (for example, the user MA) of the vehicle 10 using an information terminal (for example, the information terminal 60B), it is possible to notify the driver that vehicle 10 is in a standby state before the vehicle 10 starts traveling by the automated exiting by executing the first notification. Therefore, it is possible to improve safety and usability for traffic participants.

### Example of Image Displayed on Information Terminal

FIGS. 12 to 21 are diagrams illustrating examples of images displayed on the terminal screen 61 of the information terminal 60 in automated exiting of the vehicle 10.

FIG. 12 is a disclaimer screen 62 displayed on the terminal screen 61 of the information terminal 60 that receives the inquiry information regarding the automated exiting. The processor 81 of the information terminal 60 displays the disclaimer screen 62 on the terminal screen 61 when, for example, an application for giving a movement instruction is started. The processor 81 of the information terminal 60 displays on the disclaimer screen 62 an agreement sentence 62a indicating an agreement content such as “Cautions: This function is not a fully automatic operation”. The processor 81 also displays an agreement button 62b for the user M to operate when agreeing to the cautions. When the agree button 62b is subjected to a swiping operation (specific operation), the processor 81 displays a sentence such as “Agreed to the cautions” indicating that the cautions are agreed. The disclaimer screen 62 in FIG. 12 is a screen displayed, for example, in step S45 in FIG. 8 or steps S66 and S67 in FIG. 9.

FIG. 13 is a reception screen 63 displayed on the terminal screen 61 of the information terminal 60 during the processing of the communication connection between the vehicle 10 and the information terminal 60 in automated exiting of the vehicle 10. For example, an agreement operation by the user M regarding the disclaimer is received, the processor 81 displays the reception screen 63 on the terminal screen 61. The processor 81 displays on the reception screen 63 a connection message 63a indicating that connection processing between the information terminal 60 and the vehicle 10 is in progress, such as “connecting to vehicle”, and displays a stop button 63b for stopping this connection processing. The reception screen 63 in FIG. 13 is a screen displayed in, for example, step S46 in FIG. 8 or step S68 in FIG. 9.

FIG. 14 shows the reception screen 63 displayed on the terminal screen 61 of the information terminal 60 when the communication connection between the vehicle 10 and the information terminal 60 is completed. The processor 81 displays on the reception screen 63 a connection completion message 63c indicating that the connection processing between the information terminal 60 and the vehicle 10 is completed, such as “connection with vehicle is completed”. The reception screen 63 in FIG. 14 is a screen displayed in, for example, step S52 in FIG. 8 or step S75 in FIG. 9.

FIG. 15 is a reception screen 64 that is displayed on the terminal screen 61 of the information terminal 60 when the ignition ON instruction is received. The processor 81 displays on the reception screen 64 an ignition ON button 64a and a start message 64b prompting the start of the vehicle 10, such as “Starting to exit. Please press POWER button”.

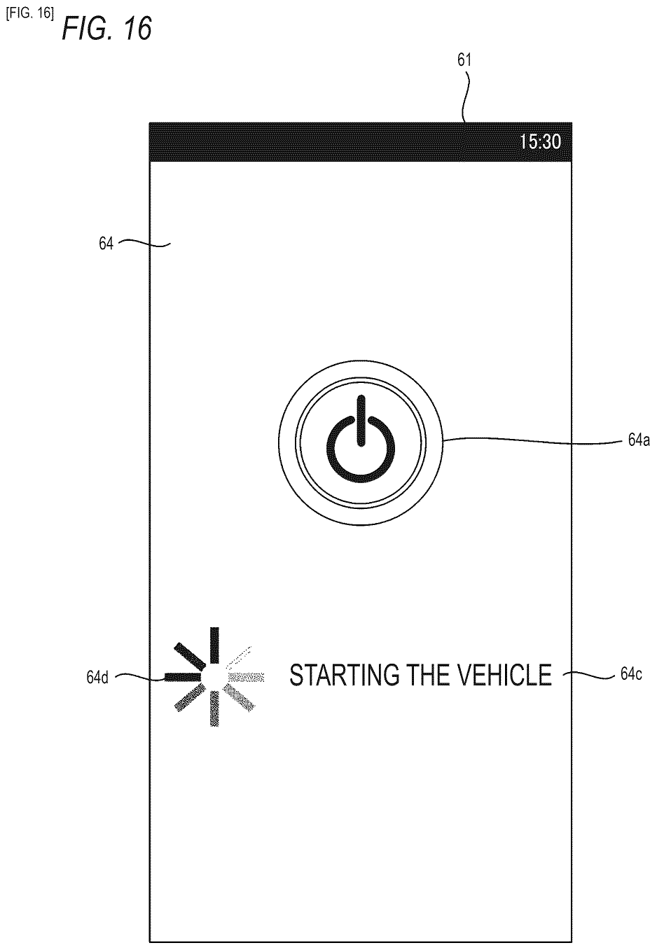

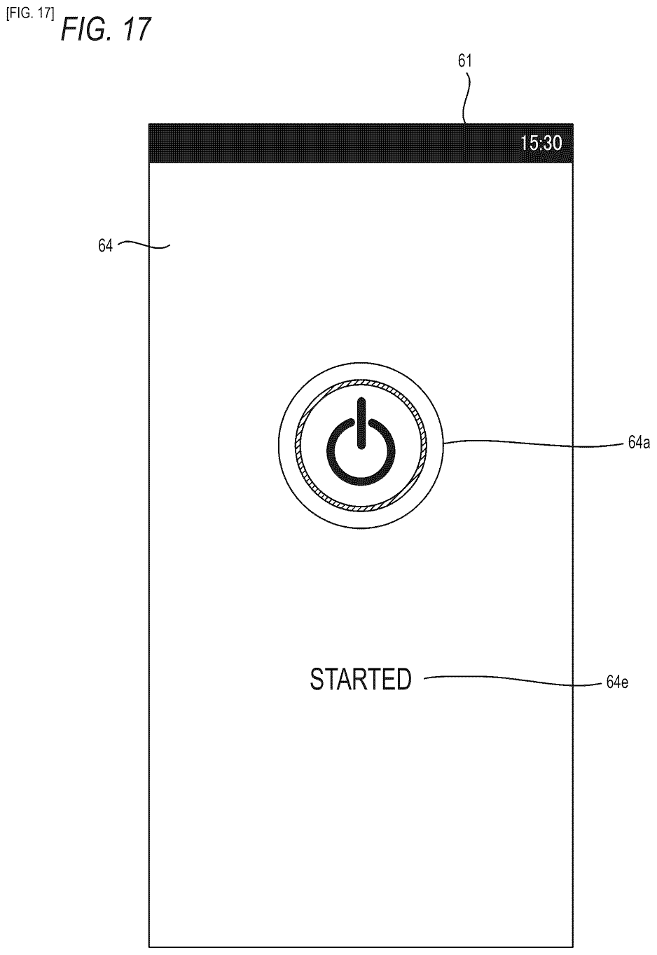

Each of FIGS. 16 and 17 is the reception screen 64 displayed on the terminal screen 61 of the information terminal 60 when the ignition ON button 64a is pressed. As illustrated in FIG. 16, the processor 81 displays on the reception screen 64 a start-up message 64c indicating that the vehicle 10 is being started, such as “starting the vehicle”, and a start-up mark 64d. As illustrated in FIG. 17, the processor 81 displays on the reception screen 64 a start completion message 64e indicating that the vehicle 10 is started such as “started”. The reception screen 64 from FIG. 15 to FIG. 17 is a screen displayed in, for example, step S83 in FIG. 10 or step S103 in FIG. 11.

FIGS. 18 and 19 show a reception screen 65 displayed on the terminal screen 61 of the information terminal 60 when receiving the action plan of the vehicle 10. As shown in FIG. 18, at the start of the reception of the action plan, the processor 81 displays on the reception screen 65 a direction selection message 65a prompting the selection of a direction for the exiting of the vehicle 10, such as “please select exiting direction”, and exiting direction arrows 65b to 65e indicating exiting directions of the vehicle 10. As shown in FIG. 19, when the action plan is received, the processor 81 displays on the reception screen 65 a direction confirmation message 65f indicating the exiting direction selected by the user M, such as “exiting forward”, and a selected exiting direction arrow 65g indicating the exiting direction. Furthermore, the processor 81 displays on the reception screen 65 an OK button 65h for determining the exiting direction and a reselection button 65i for reselecting the exiting direction. The reception screen 65 in FIG. 18 and FIG. 19 is a screen displayed in, for example, step S89 in FIG. 10 or step S109 in FIG. 11.

FIG. 20 is a charge waiting screen 66 displayed on the terminal screen 61 of the information terminal 60 when waiting for charging the sub-power supply 142. The processor 81 displays on the charge waiting screen 66 a charge waiting message 66a that gives a notification of waiting for charging the sub-power supply 142, such as “preparing for remote exiting, it will take up to 20 seconds”, and a progress bar 66b indicating a progress state of charging. The charge waiting message 66a illustrated in FIG. 20 indicates that the time until the charge control on the sub-power supply 142 is completed is 20 seconds. The progress bar 66b indicates that the charge progress rate of the sub-power supply 142 is currently 60%. The charge waiting screen 66 of FIG. 20 is, for example, a screen displayed in step S93 of FIG. 10.

FIG. 21 is a reception screen 67 displayed on the terminal screen 61 of the information terminal 60 when receiving the movement control execution instruction by the user M. The processor 81 displays, on the reception screen 67, for example, a moving icon 67a that moves following a touch position of the user M by a rotation swiping operation. The processor 81 displays a guide message 67b for executing the automated exiting of the vehicle 10 or stopping the automated exiting of the vehicle 10, such as “exit by rotation swiping” or “release finger to stop”. The processor 81 displays an execution state image 67c indicating the execution state of the exiting control for the vehicle 10 (how the vehicle moves) above a region where the moving icon 67a is displayed. Further, the processor 81 displays on a right side of the execution state image 67c an alerting message 67d for alerting the user M who performs the instruction operation, such as “please directly check surroundings”, and a stop button 67e for stopping the automated exiting control. The reception screen 67 in FIG. 21 is a screen displayed in, for example, step S95 in FIG. 10 or step S113 in FIG. 11. When a specific operation, such as a continuous swiping operation by the user M on the reception screen 67 or a rotation swiping operation in a predetermined rotation direction, is received, the processor 81 transmits a movement control execution instruction to the vehicle 10.

Note that the control method described in the embodiment described above may be implemented by executing a control program prepared in advance by a computer. The control program is stored in a computer-readable storage medium and executed by being read from the storage medium. In addition, the control program may be provided in a form stored in a non-transitory storage medium such as a flash memory, or may be provided via a network such as the Internet. The computer that executes the present control program may be provided in the control device, may be provided in an electronic device such as a smartphone, a tablet terminal, or a personal computer that can communicate with the control device, or may be provided in a server device that can communicate with the control device and the electronic device.

Although the embodiment of the present invention has been described above, the present invention is not limited to the above-described embodiment, and modifications, improvements, and the like may be appropriately made.

For example, the calculation unit 52 may further include a wiper control unit. The wiper control unit causes the wiper of the vehicle 10 to operate based on an operation of a wiper switch by the user M of the vehicle 10. When the wiper of the vehicle 10 is operating and the user M gets out of the vehicle 10, and the movement control unit 55 controls the vehicle 10 to perform automated parking (automated entering) into a predetermined parking space, the wiper control unit allows the wiper to operate during the automated parking and causes the wiper to continuously operate. Thereafter, when control is performed to cause the vehicle 10 parked in the predetermined parking space to perform automated exiting from the predetermined parking space, if the wiper switch of the vehicle 10 is operated to an operating position at which the wiper is operated, the wiper control unit prohibits the operation of the wiper during the automated exiting and stops the wiper. In this way, even when the user M forgets to turn off the wiper switch when getting off the vehicle, it is possible to prevent the wiper from starting operation when the vehicle is in automated exiting. Therefore, for example, if there is a surrounding environment or a weather condition that requires the operation of the wiper during the automated parking (automated entering) of the vehicle 10, or a surrounding environment or a weather condition that does not require the operation of the wiper during the automated exiting of the vehicle 10, it is possible to prevent malfunction or damage to the wiper or the vehicle 10 due to the operation of the wiper during automated exiting.

In the present specification, at least the following matters are described. Although corresponding constituent elements or the like in the embodiment described above are shown in parentheses, the present invention is not limited thereto.
(1) A control device (calculation unit 52) for a moving object (vehicle 10), the control device comprising:
a movement controller (movement control unit 55) configured to execute movement control of the moving object; and
a notification controller (notification control unit 56) configured to provide a first notification from the moving object and a second notification from the moving object in a manner different from the first notification, in which
the notification controller provides the first notification when an instruction for the movement control is received, and
the notification controller provides the second notification after providing the first notification, and then executes the movement control.

According to (1), the first notification is provided when an instruction for the movement control of the moving object is received, and the second notification is provided after the first notification, so that people around the moving object can be accurately notified of a moving state of a stage of movement control at which the moving object is. Therefore, the people around the moving object can be prevented from feeling anxious since they do not know the moving state of the moving object, and from feeling a sense of crisis since the moving object will enter a moving state without giving any notice. In this way, safety and usability for transport participants are improved.
(2) The control device according to (1), in which
the notification controller provides the first notification in a case where the movement control based on the instruction becomes executable, and provides the second notification at least either at a start of the movement control or during the execution of the movement control.

According to (2), the timing for providing the first notification and the second notification is preferably when it becomes possible to execute the movement control, at the start of the movement control, and during the execution of the movement control.
(3) The control device according to (2), in which
the case where the movement control based on the instruction becomes executable is a case where a user who provides the instruction is determined and the moving object is started.

According to (3), the timing for providing the first notification is preferably when the user who gives the instruction is confirmed and the moving object is started.
(4) The control device according to any one of (1) to (3), in which
the second notification has a notification intensity higher than that of the first notification.

According to (4), since the first notification and the second notification have different notification intensities, it is possible to more accurately notify the people around the moving object of the moving state at a stage of the movement control at which the moving object is in.
(5) The control device according to (4), in which
the first notification is a notification implemented by turning on a first lighting device of the moving object, and
the second notification is a notification implemented by turning on the first lighting device and a second lighting device of the moving object different from the first lighting device.

According to (5), it is preferable to differentiate the notification intensity between the first notification and the second notification by changing the number of the lighting devices that are turned on.
(6) The control device according to (4), in which
the first notification is a notification implemented by turning on a lighting device of the moving object, and
the second notification is a notification implemented by turning on the lighting device and a different type of method from turning on the lighting device.

According to (6), it is preferable to differentiate the notification intensity between the first notification and the second notification by using different notification methods for different notification types.
(7) The control device according to any one of (1) to (6), in which
the moving object includes a daytime running light, and
the notification controller provides the first notification by turning on the daytime running light when a brightness around the moving object satisfies a predetermined condition, and provides the first notification by turning on a lighting device of the moving object other than the daytime running light when the brightness around the moving object does not satisfy the predetermined condition.

According to (7), it is preferable to provide a notification by turning on the daytime running light depending on the brightness around the moving object.
(8) The control device according to any one of (1) to (7), in which
the notification controller provides the second notification by turning on a headlamp of the moving object, and
the movement controller performs restriction on the movement control when an operation unit of the headlamp of the moving object is in a state of instructing a certain operation of the headlamp.

According to (8), when the headlamp is set to a state of instructing a certain operation by an operation of the user, it is preferable to restrict the movement control that provides a notification to change a setting of the headlamp.
(9) The control device according to (8), in which
the restriction on the movement control includes prohibiting execution of the movement control, restricting a movement speed in the movement control, or restricting a movement distance in the movement control.

According to (9), it is preferable to perform restriction on the moving object by prohibiting the execution of movement control, restricting the movement speed, restricting the movement distance, and the like.
(10) The control device according to (8) or (9), further comprising:
a notification unit that notifies, when the movement controller performs restriction on the movement control, the user of an operation for releasing the restriction on the movement control.

According to (10), it is preferable that the restricted state of the movement control can be released by a user operation.
(11) The control device according to any one of (1) to (10), further comprising:
a communication unit configured to communicate with an information terminal portable by a user of the moving object, in which
the notification controller provides the first notification when an instruction for the movement control is received through communication with the information terminal, and provides the second notification after providing the first notification, and then performs the movement control.

According to (11), it is preferable that the first notification and the second notification can be provided after an instruction for movement control is given based on the operation on the information terminal carried by the user.
(12) The control device according to (11), in which
the notification controller provides the first notification when driver determination for the movement control is made, and provides the second notification when a movement direction for the movement control is determined, and then performs the movement control.

According to (12), the timing for providing the first notification is preferably when the driver of the movement control is confirmed, and the timing for providing the second notification is preferably when the movement direction of the movement control is confirmed.
(13) A control method by a control device configured to perform movement control of a moving object and configured to provide a first notification from the moving object and a second notification from the moving object in a manner different from the first notification, the control method including:
providing, by a processor of the control device, the first notification when an instruction for the movement control is received; and
providing, by the processor, the second notification after providing the first notification, and then performs the movement control.

According to (13), the first notification is provided when an instruction for the movement control of the moving object is received, and the second notification is provided after the first notification, so that people around the moving object can be accurately notified of a moving state of a stage of movement control at which the moving object is. Therefore, the people around the moving object can be prevented from feeling anxious since they do not know the moving state of the moving object, and from feeling a sense of crisis since the moving object will enter a moving state without giving any notice. In this way, safety and usability for transport participants are improved.
(14) A control program of a control device configured to perform movement control of a moving object and configured to provide a first notification from the moving object and a second notification from the moving object in a manner different from the first notification, the control program causing a processor of the control device to perform a process including:
providing the first notification when an instruction for the movement control is received; and
providing the second notification after providing the first notification, and then to perform the movement control.

According to (14), the first notification is provided when an instruction for the movement control of the moving object is received, and the second notification is provided after the first notification, so that people around the moving object can be accurately notified of a moving state of a stage of movement control at which the moving object is. Therefore, the people around the moving object can be prevented from feeling anxious since they do not know the moving state of the moving object, and from feeling a sense of crisis since the moving object will enter a moving state without giving any notice. In this way, safety and usability for transport participants are improved.

### REFERENCE SIGNS LIST

10 vehicle (moving object)
24 communication unit
52 calculation unit (control device)
55 movement control unit
56 notification control unit
57 notification unit
60 information terminal

1. A control device for a moving object, the control device comprising:
a movement controller configured to execute movement control of the moving object; and
a notification controller configured to provide a first notification from the moving object and a second notification from the moving object in a manner different from the first notification, wherein
the notification controller provides the first notification when an instruction for the movement control is received, and
the notification controller provides the second notification after providing the first notification, and then executes the movement control.

2. The control device according to claim 1, wherein
the notification controller provides the first notification in a case where the movement control based on the instruction becomes executable, and provides the second notification at least either at a start of the movement control or during the execution of the movement control.

3. The control device according to claim 2, wherein
the case where the movement control based on the instruction becomes executable is a case where a user who provides the instruction is determined and the moving object is started.

4. The control device according to claim 1, wherein
the second notification has a notification intensity higher than that of the first notification.

5. The control device according to claim 4, wherein
the first notification is a notification implemented by turning on a first lighting device of the moving object, and
the second notification is a notification implemented by turning on the first lighting device and a second lighting device of the moving object different from the first lighting device.

6. The control device according to claim 4, wherein
the first notification is a notification implemented by turning on a lighting device of the moving object, and
the second notification is a notification implemented by turning on the lighting device and a different type of method from turning on the lighting device.

7. The control device according to claim 1, wherein
the moving object includes a daytime running light, and
the notification controller provides the first notification by turning on the daytime running light when a brightness around the moving object satisfies a predetermined condition, and provides the first notification by turning on a lighting device of the moving object other than the daytime running light when the brightness around the moving object does not satisfy the predetermined condition.

8. The control device according to claim 1, wherein
the notification controller provides the second notification by turning on a headlamp of the moving object, and
the movement controller performs restriction on the movement control when an operation unit of the headlamp of the moving object is in a state of instructing a certain operation of the headlamp.

9. The control device according to claim 8, wherein
the restriction on the movement control includes prohibiting execution of the movement control, restricting a movement speed in the movement control, or restricting a movement distance in the movement control.

10. The control device according to claim 8, further comprising:
a notification unit that notifies, when the movement controller performs restriction on the movement control, the user of an operation for releasing the restriction on the movement control.

11. The control device according to claim 1, further comprising:
a communication unit configured to communicate with an information terminal portable by a user of the moving object, wherein
the notification controller provides the first notification when an instruction for the movement control is received through communication with the information terminal, and provides the second notification after providing the first notification, and then performs the movement control.

12. The control device according to claim 11, wherein
the notification controller provides the first notification when driver determination for the movement control is made, and provides the second notification when a movement direction for the movement control is determined, and then performs the movement control.

13. A control method by a control device configured to perform movement control of a moving object and configured to provide a first notification from the moving object and a second notification from the moving object in a manner different from the first notification, the control method comprising:
providing, by a processor of the control device, the first notification when an instruction for the movement control is received; and
providing, by the processor, the second notification after providing the first notification, and then performs the movement control.

14. A non-transitory computer-readable storage medium storing a control program of a control device configured to perform movement control of a moving object and configured to provide a first notification from the moving object and a second notification from the moving object in a manner different from the first notification, the control program causing a processor of the control device to perform a process comprising:
providing the first notification when an instruction for the movement control is received; and
providing the second notification after providing the first notification, and then to perform the movement control.
